(19) United States
(12) Patent Application Publication
(10) Pub. No.: US 2010/0004977 A1
(43) Pub. Date: Jan. 7, 2010

(54) Method and System For Measuring User Experience For Interactive Activities

(75) Inventors: Carl Marci, Boston, MA (US); Brian Levine, Arlington, MA (US); Ravi Kanth V Kothuri, Nashua, NH (US)

Correspondence Address: MINTZ, LEVIN, COHN, FERRIS, GLOVSKY AND POPEO, P.C, ONE FINANCIAL CENTER, BOSTON, MA, 02111, US

(73) Assignee: INNERSCOPE RESEARCH LLC, Boston, MA (US)

(21) Appl. No.: 12/426,259

(22) Filed: Apr. 19, 2009

Related U.S. Application Data
(63) Continuation-in-part of application No. 11/850,650, filed on Sep. 5, 2007.
(60) Provisional application No. 60/824,546, filed on Sep. 5, 2006.

(51) Int. Cl. G06Q 10/00

(52) U.S. Cl. 705/10

(57) ABSTRACT

The present invention is directed to a method and system for measuring the biometric (physically, behaviorally, biologically and self-report based) responses of an audience to a presentation or interactive experience that provides a sensory stimulating experience and determining a measure of the level and pattern of engagement of that audience and impact of the presentation or interactive experience. In particular, the invention is directed to a method and system for measuring one or more biometrically based responses of one or more persons being exposed to the presentation in order to determine the moment-to-moment pattern or event based pattern and overall level of engagement. The method and system can include eye tracking to determine areas of the presentation that correspond to high and low levels of biometric responses suggesting high and low levels of visual impact. Further, the invention can be used to determine whether the presentation or the content in the presentation is more effective in a population relative to other presentations (or content) and other populations and to help identify elements of the presentation that contribute to the high level of engagement or impact and the effectiveness and success (or failure) of the presentation for that population.

### CROSS-REFERENCE TO RELATED APPLICATIONS

This application is a continuation-in-part of U.S. patent application Ser. No. 11/850,650, filed Sep. 5, 2007, which is hereby incorporated by reference in its entirety. U.S. patent application Ser. No. 11/850,650 claims any and all benefits as provided by law of U.S. Provisional Application No. 60/824,546 filed Sep. 5, 2006 and U.S. 60/824,546 is hereby incorporated by reference in its entirety.

### STATEMENT REGARDING FEDERALLY SPONSORED RESEARCH

Not Applicable

### REFERENCE TO MICROFICHE APPENDIX

Not Applicable

### BACKGROUND

1. Field of the Invention

The present invention is directed to a method and system for exposing a sample user or population audience to a presentation (a sensory stimulus) and evaluating the audience's experience by measuring the physically, biologically, physiologically, and behaviorally based responses of the individual members of the audience to the presentation and determining a measure of the level and pattern of intensity, synchrony and engagement of the members of that audience to the presentation. The presentation can be a passive presentation in which the audience watches or an interactive presentation which allows the members of the audience to participate and interact in a task, process, experience or activity.

2. Description of the Prior Art

There are many different kinds of audio, visual and audio-visual presentations and activities that people are exposed to every day. These presentations serve as sensory experiences that stimulate our senses and are known to result in biologically based responses that can be measured electronically and mechanically (for example, heart rate, respiration rate, blood pressure, and skin conductance).

A commonly used approach in making measurements for evaluating these presentations is that of interrogation, wherein the television/media viewer and/or Internet user and/or game player is asked to identify himself or herself as a member of the television/media audience or as an Internet user or as a game player. In connection with television viewing, this inquiry is usually done by means of an electronic prompting and data input device (for example, as in a Portable People Meter by Arbitron, Inc.) associated with a monitored receiver in a statistically selected population and monitoring site. The member identification may also include age, sex, and other demographic data. It is common to store both the demographic data and the tuning data associated with each monitored receiver in the statistically selected monitoring site in store-and-forward equipment located within the monitoring site and to subsequently forward these data to a central office computer via a direct call over the public switched telephone network, or via the Internet, on a regular basis.

These non-biologically based self-report methods of measuring audience response are known to be highly error prone. Personal logs are subjective resulting in recall biases, home monitoring devices require event-recording by the person and suffer low compliance, while digital monitoring of cable and internet signals cannot identify which household member or members are in the audience nor can they evaluate the level of responsiveness by those members. In addition, self-report offers no ability to capture the biological responses to a media presentation. Thus, while methods of self-report offer valuable data, they are highly error prone and cannot track the moment-to-moment responses to media consumption.

With the development of the internet and its expansion into many everyday activities, people are exposed to interactive media and activities. However, the ability to measure and evaluate the user experience, effectiveness and the usability of these interactive media has been limited.

Current methodologies for measuring or evaluating user experience, effectiveness and usability of websites and other interactive internet and software media has been limited to traditional self-report and eye-tracking on an individual user basis. These prior art techniques involved asking the individual user questions about the experience and evaluating where the user was looking during the interactive activity. Some companies (e.g., NeuroFocus, EmSense) also incorporate EEG in the process and some companies propose to measure cognitive activity (e.g., Eye Tracking, Inc.) from pupillary responses. These companies use these measures in attempts to determine emotional states, such as happiness and to study the effects on implicit memory.

### SUMMARY

Traditional testing focuses on using physiologically or biologically based responses in an attempt to determine the specific emotion elicited in response to a particular stimulus, such as advertising media, be it a photograph, a print ad, or a TV commercial. However, determining the specific emotion elicited does not help to predict how these emotional responses lead to desired behavioral responses or changes in behavior. Further, this testing focuses on the responses of individuals. Thus, it is desirable to identify the physical, behavioral, physiologic and/or biologic responses or patterns and combinations of responses in a population sample (a test or representative audience) that can lead to or are indicators of desired behavioral responses or changes in behavior of the population.

Scientific research over the last two decades suggests that a person's responses to presentations can be useful for understanding the depth of processing of the content. The level of processing in turn affects the biometric impact the content can have on the target audience which may be predictive of the audience behavior or attitude. Several studies even show that more arousing content measured as a function of biometric responses leads to better recall of that content at a later date. This can be of special interest to a variety of industry professionals including but not limited to creative directors, entertainment specialists, and advertisers. For example, in the entertainment field, it can be useful to be able to assess which works are appealing to which audiences (e.g., children, senior citizens, men and women). Not only can this information be useful to the creator and the promoter in identifying the target audience, but also to corporate sponsors and advertisers for advertising purposes. The ability to estimate the overall impact of a given stimulus can also be useful to clinicians trying to educate patients, teachers inspiring students, or politicians persuading constituents. Thus, it is desirable to determine which, if any, demographic groups will find a particular piece or element of media content to be engaging in order to help anticipate its impact. Similarly, it is desirable to determine which, if any, demographic groups find a particular print, internet, television or radio commercial engaging in order to ultimately have the ability to predict human behavior, such as attitudinal change, purchasing activity, or social conduct.

The present invention relates to a system and method for use in the field of audience measurement. Specifically, the invention is directed to methods and systems for recording the physically, behaviorally, biologically and self-report based audience responses (collectively, referred to as biometric responses) to an interactive or passive presentation such as a live or recorded, passive or interactive audio, visual, audio-visual presentation, internet activity, game playing, shopping, or online shopping or purchase and for determining a measure of moment-to-moment, or event-to-event, and overall intensity, synchrony and engagement of the audience with that interactive or passive presentation as well as other measures and indices that can be used to characterize individual audience member's response to the presentation or portions of the presentation. The measure of engagement of the sample population or audience can then be used to estimate the level to which a population as a whole will be engaged by, or like or dislike, the same presentation. The measure of engagement of the audience when combined with eye-tracking technology can also be used to determine what elements of a presentation are most engaging or have the most impact relative to other elements in that or a similar presentation. The measures of intensity, synchrony and engagement, as well as other indices that are determined as a function of eye tracking and other biometric responses can be used both for diagnostic value and/or to anticipate the success or failure of a presentation. This can be accomplished via predictive models for comparing, for example, the measure of intensity, synchrony or engagement of known successful or failed (or more generally, a ranked set of) presentations to the measure of engagement for an unknown or not previously evaluated presentation for a sample population.

The invention can be used as a media testing tool used in place of or as a complement to traditional dial testing, self-report surveys and focus groups to measure audience reaction. The invention can utilize human neurobiology and embodied responses that are measured and processed in accordance with the invention to measure a sample audience reaction and predict the response of a more general audience.

In accordance with one embodiment, a sample audience can be presented with a piece of content (live or pre-recorded) or presented with an interactive activity (a task or online experience) that can last anywhere from 5 seconds to 5 hours (or more). The sample audience can be one individual person presented with the content or the interactive activity more than one time or more than one individual presented with the content or the interactive activity one or more times. The system according to the invention monitors all or a select set of the biometric responses of the users to obtain an objective measure of their response to the content or interactive activity.

The biometric response data can be gathered via a multi-sensor wearable body monitoring device that enables continuous collection of biologically based data that is time-stamped or event-stamped in order to correlate it to the presentation. This sensor package can include one or more sensors to measure skin conductivity (such as galvanic skin response) and can include any number of additional sensors and/or cameras to monitor responses such as heart rate and heart rate variability, brain wave activity, respiration rate and respiration rate variability, head tilt and lean, body position, posture and movement, eye tracking, pupillary responses, micro and macro facial expressions, and other behaviorally and biologically based signals.

The content that is presented to the audience as part of the presentation can include, but is not limited to, photographs, print advertisements, television programs, films, documentaries, commercials, infomercials, news reports, live content, live theater, theater recordings, mock trials, story boards, actor auditions, television pilots and film concepts, music, the Internet, shopping, purchasing products and services, gaming, and other active and passive experiences.

In accordance with the invention, the response data can be collected individually (the user experiences the presentation alone), in a small group, or large group environment and be noninvasive (all sensors can be external). In addition, the response data can be collected in a controlled environment such as a testing or monitoring facility or in an ‘at-home’ environment (either real or simulated).

In accordance with the invention, the system can track what presentation is being viewed, who is viewing the content and the biometric response(s) of the audience members in time-locked or event associated correspondence to the viewed content or presentation. Thus, for a given piece of content or a presentation being viewed, the physical, behavioral and biological response(s) of each member of the sample population or audience can be associated with a portion of the content and the data from more than one sample population or audience gathered at different times and places can be combined. For the purposes of this invention, the sample audience (or sample population) can be a single individual who is monitored viewing the same content several times, such as over the course of several days, as well as more than one individual viewing the same content at least one time.

In one embodiment of the invention, the audience can have specific demographic characteristics based on age, gender, or character and personality traits (e.g., those based on the ten-item personality index, TIPI in psychology literature), or can represent specific audience segments of interest for a particular client (based on predefined criterion for audience segmentation/selection).

In one embodiment of the invention, a system according to the invention can help content creators, distributors and marketers gain an objective view of how their audiences will respond to their content. The system can be used in a controlled testing environment to measure biometric and other responses of sample audiences to presented content.

In one embodiment of the invention, the system can be used in a natural home environment and be as noninvasive as possible. The system can track what television (and other media, such as the internet) is being viewed by household members, which members are viewing and exactly which segments those members are watching.

The members of the household, they can control their media in the same way as before. For them, the main difference is that they must wear or be within range of a sensor device (for example, a special article of clothing, a bracelet or other device) as they view or experience the content. In this example, this device can be used to determine (by using biological sensors) how engaged they are with the media being played. The system can make assessments about the data collected, for example, the greater the level of movement, the less likely the audience member is paying attention and the more likely they are engaged in a non-passive viewing experience.

In one embodiment, the data collected by the device can only be used if the device or the viewer is determined to be close to the media display; otherwise, it is assumed the viewer is too far away from the media to experience it. The data can be transmitted to the set-top box (STB) or other receiver at regular intervals and associated with each audience members' identification plus information about the current media being consumed. This data can be packaged together in a database and served in real time.

In one embodiment of the system, to address compliance issues, users will not be able to change the channel unless they are wearing (or within operating range of) a functioning sensor device or charging a discharged unit in the outlet/dock attached to the STB or receiver.

This system according to the invention can be used by presentation and content creators to evaluate their programming before widely distributing it. For example, they can use the system to evaluate a sample audience by “pushing” the video and audio they want evaluated directly to a sample audience member's home entertainment systems or computer.

In another embodiment of the invention, the system can be used to monitor, aggregate, and analyze the combination of biometric responses for a selected audience in a real-time manner. This analysis could be used to drive further audience research. For example, in a post viewing focus group, the moderator can identify the key moments (determined from an analysis of the engagement map) and ask the members of the focus group specific questions related to those moments.

In another embodiment of the invention, the system can include a reference database to compare a current set of audience responses to the reference database and score and rate the current set of responses. The reference database can include engagement measures as well as intensity and synchrony measures (or performance metrics derived therefrom) that can be compared with the corresponding measures for a target presentation or activity. The results of the comparison can be used to predict the success or effectiveness of the target presentation or activity.

In accordance with the various embodiments of the invention, enhanced user experience testing for interactive activities can combine measuring of various physical, behavioral, physiologic and/or biologic responses or patterns or combinations of responses, including the intensity levels or amplitude of the responses and synchrony of the responses to particular elements of the activity and across the sample population of individual members of the audience.

In accordance with one embodiment of the invention, biometric measures can be used to evaluate the entire experience by comparing biometric responses using a weighted frequency distribution based on eye tracking combined with multiple methodologies and sensor arrays. The eye-tracking measures can include, but are not limited to, visual attention as estimated by gaze location, fixation duration, and movement within a localized area. Biometric measures can include, but are not limited, to pupillary responses, skin conductivity, heart rate, heart rate variability, brain-wave activity, respiration activity, head and body movement, lean, posture and position, facial micro and macro-expressions, mouse pressure and derivatives of the above-said measures. Behavioral type biometric responses can include, but are not limited to, facial micro and macro-expressions, head tilt, head lean, body position, body posture, body movement, and amount of pressure applied to a computer mouse or similar input or controlling device. Self-report type biometric measures can include, but are not limited to, survey responses to items such as perception of the experience, perception of usability or likeability of experience, level of personal relevance to user, attitude toward content or advertising embedded in the content, intent to purchase product/game or service, and changes in responses from before and after or pre-post testing. Self-report measures can be informed or influenced by presenting the user with their eye tracking, biometric and/or behavioral responses or the aggregated responses of a group of users.

Combinations of the above metrics can be aggregated, presenting the information in a two-dimensional or three-dimensional space relative to a stimulus or interactive experience, around pre-defined areas of interest within a stimulus or interactive experience, across a task, process, experience, or the measures can be used to define areas worthy of additional study or exploration (i.e., areas of particularly high cognitive or emotive response). Combinations of the above metrics can also be used to assess tasks in an interactive environment, such as an internet environment, game playing, searching for information, shopping or for online shopping and purchases. For example, eye-tracking can be used to identify where visual attention is focused and then one or more biometric responses at that moment can be determined. The reverse analyses can also be performed, i.e., areas of cognition or heavy cognitive work load (as measured, for example, by pupil response, brain wave activity or EEG) and strong emotive responses (as measured, for example, by skin conductance, heart rate and respirations) can be calculated and eye-fixations and locations can be used to identify the visual element or component or area being viewed during an experience that lead to the response. Behavioral data such as head tilt and lean, body position and posture, and the amount of pressure applied to an input device, such as a computer mouse or similar input or content controlling device can be used to assess a level of interest and/or frustration while micro and macro facial expressions can be used to aid in emotion (interest and frustration) measurement and evaluation. Further, data from the measures described can be shown or described to users in a “biometrically” informed self-report to deepen user awareness of implicit or unconscious responses for additional insights into the user experience. Demographic and psychographic information can be used to segment users into groups for analyzing user experience with biometric responses as defined above and combinations of biometric responses can also be used to define user groups, “behavioral” or “biometric” personas or profiles that may be of interest to content creators and advertisers.

These and other capabilities of the invention, along with the invention itself, will be more fully understood after a review of the following figures, detailed description, and claims.

### BRIEF DESCRIPTION OF THE FIGURES

FIG. 1 is a schematic diagram of a system according to an embodiment of the invention for audience measurement in a test theater or facility.

FIG. 2A is a schematic diagram of a second embodiment of the system according to the invention for audience measurement in the home.

FIG. 2B is a flow diagram of the in-home compliance algorithm for the second embodiment.

FIG. 2C is a flow diagram of one aspect of the in-home system embodiment, its ability to identify who in a given household is actually experiencing media.

FIG. 3 is a schematic diagram of the third embodiment of the system according to the invention for monitoring levels of engagement during social interaction.

FIG. 4A shows an engagement pattern for a 30 second commercial according to one embodiment of the invention.

FIG. 4B shows an engagement pattern for a 60 second commercial according to one embodiment of the invention.

FIG. 5 is a schematic diagram of a system according to an embodiment of the invention for audience measurement of an interactive activity.

FIG. 6 is a schematic diagram of a system according to an embodiment of the invention for audience measurement of an alternate interactive activity.

### DETAILED DESCRIPTION OF PREFERRED EMBODIMENTS

The present invention is directed to a method and system for measuring an audience's biometric (physical, behavioral, biological and self-report) responses to a sensory stimulus and determining a measure of the audience's engagement to the sensory stimulus. In particular, the invention is directed to a method and system for measuring one or more biometric responses of one or more persons being exposed to a sensory stimulus, presentation or interactive activity in order to determine the moment-to-moment or event-to-event, and overall level of engagement. Further, the invention can be used to determine whether the presentation or interactive activity is more effective in a population relative to other presentations and other populations (such as may be defined by demographic or psychographic criterion) and to help identify elements of the presentation that contribute to the high level of engagement and the effectiveness and success of the presentation.

There are many different kinds of audio, visual and audio-visual presentations that people are exposed to every day. These presentations serve as stimuli to our senses. Many of these presentations are designed to elicit specific types of responses. In some instances, an artist, musician or movie director has created a presentation that is intended to elicit one or more emotions or a series of responses from an audience. In other instances, the presentation is intended to educate or promote a product, a service, an organization, or a cause. There are also applications where the audience is exposed to or interacts with one or more live persons such as during a focus group, during an interview situation, or any such social interaction. The audience can also be presented with an interactive activity or task that can include one or more audio, visual and audio-visual presentations and allows the audience to interact with a computer, an object, a situation, an environment, or another person to complete an activity or task.

These sensory stimuli can be in the form of a sound or a collection of sounds, a single picture or collection of pictures or an audio-visual presentation that is presented passively such as on television or radio, or presented in an interactive environment such as in a video game, live interaction or internet experience. The sensory stimuli can be pre-recorded or presented live such as in a theatrical performance or legal proceeding (passive) or a real-world situation (virtual reality or simulation) such as participating on a boat cruise, focus group, online activity, board game, computer game, or theme park ride (interactive).

Current non-biologically based methods of measuring audience response are known to be highly error prone. Personal logs are subjective resulting in recall biases, home monitoring devices require event-recording by the person and suffer low compliance, while digital monitoring of cable and internet signals cannot identify which household member or members are in the audience nor can they evaluate the level of responsiveness by those members. Other methods of self-report offer valuable data, but it are highly error prone and cannot track the moment-to-moment responses to media consumption and participation in interactive activities.

Responses that are based in human biology can have multiple physiologic and behavioral correlations. The eye-tracking measures can include, but are not limited to, visual attention as estimated by gaze location, fixation duration, and movement within a localized area. Biometric can measures include, but are not limited to, pupillary responses, skin conductivity, heart rate, heart rate variability, brain-wave activity and respiration activity. Behavioral type biometric responses can include, but are not limited to, facial micro and macro-expressions, head tilt, head lean, body position, body posture, body movement, and amount of pressure applied to a computer mouse or similar input or controlling device. Self-report type biometric measures can include, but are not limited to, survey responses to items such as perception of the experience, perception of usability or likeability of experience, level of personal relevance to user, attitude toward content or advertising embedded in the content, intent to purchase product, game or service, and changes in responses from before and after or pre-post testing.

There are many commercially available products and technologies that allow continuous unobtrusive monitoring of biometrically and behaviorally based human responses most often employed for health and fitness purpose. One product, offered under the name LifeShirt System (VivoMetrics, Ventura Calif.) is a garment that is worn unobtrusively by a person being evaluated and can simultaneously collect pulmonary, cardiac, skin, posture and vocal information for later analysis. The Equivital system (Hidalgo, Cambridge UK), can collect heart rate, respiration, ECG, 3-axis motion and can integrate skin conductance. Similar features are also offered by the Bioharness system (Zephyr Technologies, Auckland, New Zealand), the Watchdog system (QinetiQ, Waltham Mass.), BT2 Vital Signs wristwatch (Exmocare, Inc., New York, N.Y.) and Bionode systems (Quasar, San Diego Calif.). Another product, offered under the name Tobii x50 Eye Tracker or Tobii 2150 (Tobii Technology, McLean Va.) is an eye-tracking device that allows for unobtrusive monitoring of eye-tracking and fixation length to a high degree of certainty. By combining eye-tracking with a biologically based engagement metric, the system can uniquely predict which specific elements within a complex sensory experience (e.g., multimedia presentation or website) are triggering the response. This technology also records additional biometric measures, such as pupillary dilation. Other companies developing this technology include Seeing Machines, Canberra, Australia. Another technology, developed at the MIT Media Lab, (MIT, Cambridge, Mass.) provides a system for measuring behavioral responses including, but are not limited to, facial micro and macro-expressions, head tilt, head lean, and body position, body posture and body movement. Another technology, developed at the MIT Media Lab, (MIT, Cambridge, Mass.) provides a system for measuring behavioral responses including, but not limited to, the amount of pressure applied to a computer mouse or similar controlling device.

While many systems have been put forward for identifying individual emotions, no system has been proposed that can reliably and objectively quantify specific and overall responses to passive and interactive audio, video, and audio-video content. One likely reason for this failure is the complexity and subjectivity of human emotional experience. Rather than use individual biological responses to identify individual emotions in individual participants, the present invention is designed to aggregate biologically based responses of a population to create a moment-to-moment or event based, and overall index of engagement and impact of the stimulus or presentation. This can be accomplished according to one embodiment of the invention by determining measures of intensity of responses and measures of synchrony of the responses to stimuli (either on a moment-to-moment basis or on an event basis) and across the sample population.

The present invention is directed to a method and system for collecting data representative of various biometrically based responses of a person (or animal) to a passive or interactive presentation. The presentation can include an audio, visual or audio-visual stimulus, such as a sound or sequence of sounds, a picture or a sequence of pictures including video, or a combination of one or more sounds and one or more pictures, including video. The stimulus can be pre-recorded and played back on a presentation device or system (e.g. on a television, video display, projected on a screen, such as a movie) or experienced as a live performance. The stimulus can be passive, where the audience experiences the stimulus from a stationary location (e.g., seated in a theater or in front of a television or video screen) or the stimulus can be interactive where the audience is participating in some form with stimulus (e.g., live roller coaster ride, simulated roller coaster ride, shopping experience, computer game, virtual reality experience or an interactive session via the internet). The data collected can be processed in accordance with the invention in order to determine a measure of engagement and impact of the person (or animal). The measure of engagement and impact for a population sample can further be used to predict the level of engagement and impact of the population. In the context of this disclosure, the sample population audience can include the measure of engagement and/or impact of a plurality of individuals to the same stimulus or multiple measures of engagement and/or impact of a single individual exposed to the same stimulus multiple times.

In accordance with the present invention, a measure of the intensity of the response to the stimulus over the period of exposure to the stimulus and a measure of the synchrony of the response to the stimulus over the period of exposure to the stimulus can be determined from the biologically based responses, including biometric responses and behavioral responses. Further, the period of exposure can be divided into time slots or windows, or event based units and a response value determined for and associated with each time slot or event window. The measure of intensity can include measuring the change, from a base level, of a biologically based response to the stimulus. Further, the response value can be determined as a function of the measured change and a set of predefined thresholds.

The system can include three time-locked or synchronized sources of data: 1) a media device for presenting a sensory stimulus or series of stimuli, 2) a monitoring device for the collection of a plurality of biological responses to the sensory stimulus, and 3) an eye-tracking system and/or video camera to determine the location and duration of pupil fixation, dilation and facial responses. Additional video cameras can be used to determine the proximity of the individual and/or audience to the media device and the specific elements of the sensory stimulus being experienced. The biometric response monitoring device and the eye-tracking system and/or video camera can be synchronized with the media device presenting the sensory stimulus so that the monitoring device and the eye-tracking system and/or video camera can consistently record the biometric responses and gaze location, duration and movement, that correspond to same portions of the presentation for repeated exposures to the presentation. The system sensor package can include, but is not limited to, a measure of skin conductivity, heart rate, respirations, body movement, pupillary response, mouse pressure, eye-tracking and/or other biologically based signals such as body temperature, near body temperature, facial and body thermography imaging, facial EMG, EEG, FMRI and the like. The test media content can include, but is not limited to, passive and interactive television, radio, movies, internet, gaming, and print entertainment and educational materials as well as live theatrical, experiential, and amusement presentations. The three time-locked data sources can be connected (by wire or wireless) to a computerized data processor so the response data can be transferred to the computerized data processor. The computerized data processor can automatically apply the described methodologies of scoring, resulting in a map of engagement per unit time, per event, or aggregated across the entire test sample population or stimuli.

The system is further able to use eye-tracking, directional audio and/or video, or other technology to isolate specific elements or moments of interest for further in-depth processing. In accordance with the invention, the system can track what content is being viewed, who is viewing the content and which physical, behavioral and biological responses of the audience members correspond to the viewed content on a moment-to-moment basis or on a per event basis.

The system can provide an objective view of how an audience will respond to a passive or interactive presentation. The system can further include a database of biometrically based audience responses, response patterns and audience intensity, synchrony and engagement patterns and levels, and performance metrics (as may be derived therefrom) to a variety of historic media stimuli that, when combined with demographic and other data relevant to the test media content, allows for a prediction of the relative success of that content, presentation or interactive experience.

A method is described for calculating an index of time-locked or event based engagement. The method involves the aggregation of the various selected measured biometric (physical, behavioral, biological and self-report) responses of the sample audience. In order to aggregate the responses of a sample population or group of participants, it is desirable to process the data according to one or more of the following procedures:
1. Time-locking or event-locking the individual data streams into time slots or event windows; the measured response data can be divided into blocks or sequences of blocks that are associated with specific time slots or event windows;
2. Determining and processing the data based upon individual baselines and individual variances; the measured response data can be normalized to compensate for varying responses of the individual members of the sample population and the sensing equipment used;
3. Determining and processing the peak and trough values for each time slot or event window to compare with the individual baselines and variances and determining and processing the rate of change for each time slot of one or more individual measured responses;
4. Determining a standardized score per time slot or event window for each measured response value;
5. Combining the standardized score per time slot or event window across the sample population using one or more of the standardized scores for one or more of the measured responses to create a measure of intensity. Preferably, more than one measured response is used with at least one measured response being weighted differently than other measured responses, depending on the sample population and presentation or content;
6. Averaging the inverse of the residual variance of the rate of change per unit time or per event of a subset of measured responses across the test audience to create a measure of synchrony with some measured responses being weighted differently than other measured responses depending on the test population and test content; Alternatively, synchrony can be determined as a function of the rate of change of intensity levels and the variance in the rate of change across subjects.
7. Combining the measure of intensity and the measure of synchrony to create an overall measure of engagement per unit time or per event; Preferably, either the measure of intensity or the measure of synchrony can be weighted differently, depending on the sample population and the presentation or content;
8. Standardizing the resulting measure of engagement per time slot or per event window to a set number of individuals (sample population size) for comparison with other tests in other populations of various sizes.

In accordance with one embodiment of the system, a sample audience is presented with a sensory stimulus or piece of media content (live or pre-recorded) in a test theater that can last from a minimum of a few seconds to several hours. For the purposes of this invention, the sample audience can be a single individual who is monitored viewing the same content several times or a group of individuals monitored viewing the same content one or more times. Monitoring of audiences can be done individually, in small groups, or in large groups, simultaneously or as different times. The audience can be of a tightly defined demographic/psychographic profile or from a broadly defined demographic/psychographic profile or a combination of the two. The system records the time-locked or event locked data streams, calculates the level of moment-to-moment or event base engagement, and compares the pattern of engagement to a database of similar media content.

The system can use eye-tracking or other technology to isolate specific elements, areas or moments of interest for further analysis or processing. In accordance with the invention, the system can track what content is being viewed, who is viewing the content (including by gender and demographic/psychographic profile), which areas or sub-areas of the content are being focused on by each individual and which measured responses of the audience correspond to the viewed content. Thus, for a given piece of stimulus content in a passive or interactive presentation, the measured responses can be connected with the portion of the content that elicited the response and the data from more than one sample audience or a subset of sample audiences gathered at different times and places can be aggregated.

In accordance with another embodiment, participating members of a household can control their media choice and usage throughout the course of their day while they wear a sensor device (for example, a special article of clothing, a bracelet or other device) that measures some combination of responses as they watch television, listen to music, or use the internet. In this embodiment, the in-home sensing device communicates with an in-home computer or set top box (STB) that determines the nature and timing of the media content the participant has chosen as well as identifying information about the participant. The system would include a technology that could determine the distance from the media stimulus such as distance measurement via technologies like infrared, global positioning satellite, radar or through the acquisition of a signal between two objects, such as the television or computer and participant using technologies with a known range of operation (e.g., WiFi, Zigbee, RFID, or Bluetooth) and/or the direction of the participant eye-gaze (e.g., using eye-tracking technology). In a variant of this embodiment, the STB or computer can prevent activation of home media devices unless the sensor device was activated to ensure compliance. In another variant of this embodiment, test presentation content and/or broadcast/cable presentation content can be “pushed” to the participant that “matches” a desired demographic/psychographic profile or pre-determined level or pattern of engagement. As in prior embodiments, the system can record the time-locked or event based data streams, calculate the moment-to-moment or event based level of engagement relative to that person, and compare the pattern of engagement to a database of similar individual experiences.

In accordance with another embodiment, the presentation that provides that sensory stimulus can be a live person or persons or activity. This live person or persons may include, but is not limited to, live focus group interactions, live presentations to a jury during a pre-trial or mock-trial, an interview-interviewee interaction, a teacher to a student or group of students, a patient-doctor interaction, a dating interaction or some other social interaction. The live activity can be an activity, for example, riding on a rollercoaster, in a boat or in a car. The live activity can be an everyday activity like shopping in a store, performing yard work or home repair, shopping online or searching the internet. The live activity can also be a simulated or virtual reality based activity that simulates any known or fictional activity. The system can record the time-locked or event locked data streams, calculate the moment-to-moment level of engagement, and similar to the other embodiments, compare the pattern of engagement to a database of similar social interactions to make an estimate of the response pattern relative to other response patterns for that type of social interaction.

The present invention relates to a system and method for use in the field of audience measurement. A system is described for recording the biometrically based audience responses to a live or recorded, passive or interactive audio, visual or audio-visual presentation that provides a sensory stimulating experience to members of the audience. A method is described for using the measured audience responses to calculate a pattern of intensity, synchrony and engagement measures. The method can involve the conversion of the measured responses of a plurality of participants into standardized scores per unit time, per event, or aggregated over time/events that can be aggregated across the sample population audience. The system determines the intensity and synchrony of the moment-to-moment or event based experience and the overall experience for the sample population audience. The standardized intensity and synchrony scores can be combined to create an overall measure of audience engagement. The measure of engagement represents an objective measure of the experience of a defined audience segment based on a plurality of biologically based measures.

The measure of engagement can be determined from two components which are determined from the plurality of biometrically based measures. The first component is the measure of intensity, which reflects the amplitude or intensity of the biometrically based responses to a plurality of defined portions of the presentation or activity (represented by time slots or event windows). The second component is the measure of synchrony, which reflects the correlation or coincidence of the change in the measured responses (how many people had the same or similar responses to the same content) in the sample population for a plurality of defined portions of the presentation (represented by time slots or event windows)

The system can further integrate time-locked or event locked eye-tracking and other video monitoring technology with the measure of engagement to identify specific elements of the sensory stimulus that are triggering the responses. The system can also use the measure of engagement to anticipate the relative success or failure of the test stimulus via predictive models using a database of historic patterns of engagement for similar test stimuli in similar audiences.

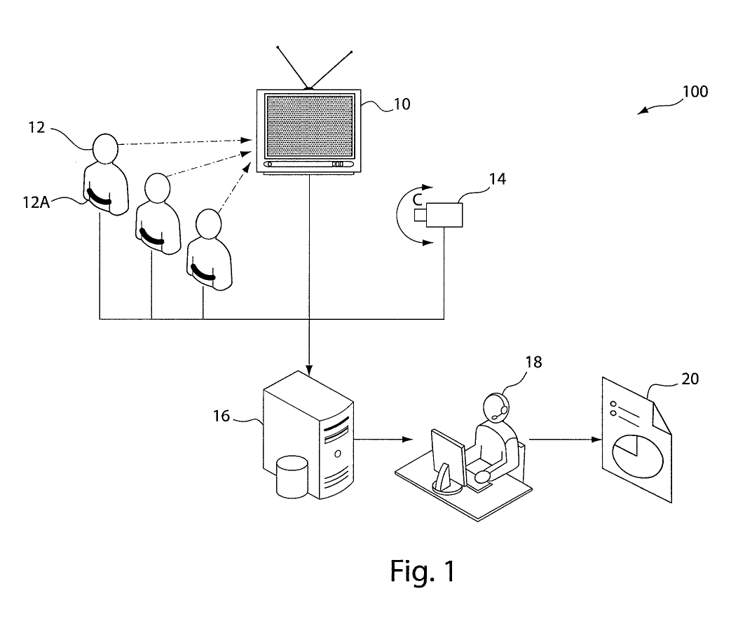

FIG. 1 shows a schematic diagram of an embodiment of the system according to the invention. The presentation is presented to the audience 12 via a display device 10, such as a video display screen or other commercially available technology for presenting the presentation to the test or sample audience 12. The presentation can include, but is not limited to, passive and interactive television, radio, movies, internet, gaming, and print entertainment and educational materials. The display device 10 can include but is not limited to a television, movie screen, a desk-top, hand-held or wearable computer device, gaming console, home or portable music device or any other device for the presentation of passive or interactive audio, visual or audio-visual presentation. For the purposes of this invention, the test audience 12 can be a single individual who is monitored viewing the same content several times, or any small or large group defined by any number of parameters (e.g., demographics, level of interest, physiological or psychological profile) who is monitored viewing the content one or more times. The test audience can be monitored using a monitoring system 12A for the collection of a plurality of physical, behavioral, and biological responses and a self-report device 12B for the collection of self-report responses, all time-locked or event locked to each other and the test stimulus or interactive presentation. The system can include a focus and/or facial monitoring system 14 (e.g., eye-tracking system, or one or more digital video cameras C) for the collection of data on the behavior, facial response and/or precise focus of the individual members of the audience. These data-sources (media stimulus, measured response data, and focus data) can be synchronized or time-locked and/or event-locked to each other whereby the response data collected is associated with a portion of the presentation and sent to a computer data processing device 16. The computer data processing device can be a general purpose computer or personal computer with a processor, memory and software for processing the biological response data and generating the intensity, synchrony and engagement values. The data sources can be time-locked, event-locked or synchronized externally or in the data processor 16 by a variety of means including but not limited to starting them all at the same time, or by providing a common event marker that allows the each system (in data processor 16) collecting the data from the three data sources to synchronize their clocks/event timers or simply synchronizing the clocks in each of the systems or use a common clock. The data processing device 16 can run software that includes the scoring algorithm to calculate the moment-to-moment, event-to-event or total level of engagement and compares it to a database of other audience responses to the same or similar test presentations and delivers the results to a user-interface 18. The user interface 18 can be provided on a desktop or portable computer or a computer terminal that accesses data processor 16. The user interface 16 can be a web based user interface or provided by a dedicated client running on the desktop or portable computer or computer terminal. The results can be interpreted and collected into a printed or electronic report 20 for distribution. The response data can be associated with the portion of the presentation that was displayed when the response was measured. Alternatively, the response data can be associated with an earlier portion of the presentation that is presumed to have caused the response based on a determined delay.

The monitoring device 12A for measuring biometric responses can include any of a number of commercially available or other sensors known in the art for measuring such responses. In accordance with the invention, the least invasive and obtrusive sensors with the most comfortable form factor should be chosen to minimize disruption of the experience. Preferably, the sensors should allow participants to experience the presentation or test stimulus “as if” they were not being monitored at all. Form factors include but are not limited to wearable devices such as “smart” garments, watches, and head-gear and remote sensing devices such as microphones, still and video cameras. Many devices are available and known to collect measures of the autonomic nervous system, facial musculature, motion and position, vocal features, eye-movements, respiratory states, and brain waves. Multiple combinations of sensors can be used depending on the sensory stimulus, population, and location of the monitoring.

The self-report device 12B can be any of the well known devices for permitting an audience member to report their response to a presentation or interactive activity. Typically, self-report devices 12B include a knob, a slider or a keypad that is operated by the audience member to indicate their level of interest in the presentation. By turning the knob, moving slider or pressing a specific button on the keypad, the audience member can indicate their level of interest in the presentation or interactive activity. Alternatively, self-report device 12B can be a computer keyboard and/or mouse that an audience member can use to interact with the presentation. Mouse movements in association with icons or elements on the computer screen can be used to indicate levels of interest. In addition, the mouse or other input device can include sensors, such as force and pressure sensors for measuring the forces applied to the mouse by the audience members. Alternatively, keyboard keys (up arrow, down arrow, page up and page down), can used to indicate levels of interest. In addition, the user can type in responses to questions or select answers to multiple choice questions.

An example of a method according to the invention for determining a measure of engagement can include the following:

Each measure of intensity (for one or more of the measured biometric responses) can be associated with a point in time or a window or bin of time or event marker within the exposure period. This association can be accomplished using many methods. Preferably, the methodology for associating a measure of intensity with a window of time or an event within the exposure period is the same or similar for each measure of engagement determined in a population sample. For example, in one method, a given measure of intensity associated with a change in a measured response is assigned to the time slot or event window that corresponds to where one half the rise time of that response occurs.

For example, the input to the data processor 16 can be an N by M data matrix where N is the number of subjects and M is the number of time points or events during which the measured response is recorded. The data processor 16 can include one or more software modules which receive the measured response data and generate the N by M matrix that is used in subsequent processing steps. The data processor 16 can include an intensity processing module which receives the N by M matrix of measured response data, calculates one or more standardized scores for each response measured and for each time slot or event window. The output can be a total integer score of the intensity of response across subjects in time windows of W seconds wide (this can be a variable parameter that depends on the presentation) or event windows. The fractional rise time parameter (f-rise) can be used to estimate the related time slot or event window in which the response occurs. For example, if a change in a biometrically based response occurs over three time slots or event windows, W1, W2, W3, and one half the rise-time of the response occurred during window W2, the measure of intensity for the change in response would be associated with window W2. Alternatively, the measure of intensity could be associated with the window that contained the peak (i.e. window W3) or the window that contained the trough (i.e. window W1). In addition, a fractional standard deviation parameter (f-std) can be used to estimate the degree of the change in response from baseline and the window can be assigned as a function of the fractional standard deviation parameter. Alternatively, the measure of intensity can be associated with one or more of the time slots or event window over which the change in response is recorded. In an alternative embodiment, the measure of intensity can be assigned to a time slot or event window as a function of the measured response as compared to a predefined baseline or mean response value or a threshold which is a function of the average response and K*standard deviation, where k is an analysis specific parameter between 0.5 and 2.5.

As a result, for each person, a response map can be determined as a set of intensity values associated with each time or event window during which each person was exposed to the passive or interactive presentation. The measure of intensity for the sample population can be determined by adding the measure of intensity associated with the same time or event window for each person exposed to the presentation. The result is a response time line that is the aggregate of the population sample. The response patterns for two or more measured responses (e.g. skin conductivity, heart rate, respiration rate, motion, etc.) can be combined (evenly or unevenly weighted) in a time window by time window basis or event window by event window basis, to determine an overall intensity score or intensity time line. The aggregate can be normalized for a population size, for example 10 or 25 people.

In accordance with the invention, the response map or response pattern can be used to evaluate radio, print and audio-visual advertisements (for both television and the Internet), television shows and movies. In one embodiment, a population sample can be exposed to one or more known successful advertisements (TV shows, movies, or websites) and then the same or a different population sample can be exposed to a new advertisement (TV show, movie, or website). Where the response pattern is similar to the response pattern to one or more known successful advertisements (TV shows, movies, or websites) it would be expected that the new advertisement (TV show, movie, or website) would also be successful. Further, a database of response patterns for different types of stimuli (advertisements, TV shows, movies, websites, etc.) could be maintained and analyzed to determine the attributes of a successful advertisement, TV show, movie, or website. Response maps and response patterns for specific demographic and psychographic groups can be produced and used to evaluate the presentation with respect to its engagement by the demographic or psychographic group.

In accordance with the invention, the data processor 16 can include a synchrony processing module which receives the N by M matrix of measured response data, calculates the inverse variance of the rate of change of one or more measured responses across at least a portion of the sample population and determines a standardized value representative of the synchrony for a given time slot or event window. The data processor 16 can determine the synchrony of a given measured response by evaluating the slope of the response in a given time window or event window over the period of exposure for each person in the population sample. For each time slot or event window, a slope value can be assigned based on the value of the slope, for example, the greater the slope, the greater the slope value. The slope value for each corresponding time window or event window of each person of the population sample can be processed to determine a measure of the variance over the population sample for each time window or event window. For example, the mean and standard deviation of the slope value of the population sample for each time window or event window can be determined and used to further determine the residual variance. The residual variance can be further normalized and used to produce a response pattern that indicates the time-locked or event locked synchrony of the response of the population sample to the stimulus.

Similarly, the synchrony response map or pattern can be used to evaluate radio, print and audio-visual advertisements (for both television and the Internet), television shows, movies, and interactive presentations. Further, the stimuli described can be evaluated using both the intensity response pattern and the synchrony response pattern.

### Intensity Score

The intensity score can be calculated according to the following steps. Step 1: Following a noise reduction process for each input channel (for example, each biometric sensor can be assigned a separate channel), for each participant, the distribution of amplitudes of responses including the mean (μ) and standard deviation (σ) of responses is calculated over some baseline period (this is a variable parameter that depends on the stimulus). Step 2: For each participant, the location and timing of the trough and peak amplitude of each response is estimated and the difference between each peak and trough (the amplitude of response) is calculated. Step 3: The values so determined are used to establish a score for each individual response thus: score 0 if the amplitude is less than the baseline μ for that channel, score 1 for a response if the amplitude is between μ and μ+f−(σ), and score 2 for a response if the amplitude is greater than μ+f−(σ). Step 4: Each response score for each participant is assigned to a sequential bin of variable length time-locked to the media stimulus by locating the time of the f-rise. Step 5: The sum of all the binned response scores across all participants is calculated for each biological sensor. The score is normalized depending on the number of sensors collected (being equal for each test) and the number of participants (being unequal for each test). The score thus created is the intensity score per unit time or per time slot.

Depending on the sensors used and the presentation being experienced, not all channels will be added to the intensity score. For example, certain forms of respiration (such as a sigh indicative of boredom) or motion (taking a drink or looking at a watch) may actually be subtracted from the intensity score. In addition, alternative versions of the intensity measure can be determined for presentations with differing goals. For example, when testing a horror movie, sensors such as skin conductance may be weighted more heavily in the calculation because the goal of the content is to generate arousal while testing a comedy, which is meant to elicit laughter, might use stronger weighting towards the respiratory response.

### Synchrony Score

Synchrony is a measure of the rate of change of a response by the audience (plural members of the sample population) to a portion of the stimulus or presentation. Multiple viewings or experiences by the same participant can be considered the same as a single viewing or experience by multiple participants. The audience can be exposed to the stimulus or presentation over a period of time or through a sequence of steps or events. The period of exposure can be divided into windows or portions or events that correspond to elements or events that make up the stimulus or presentation. For example, the synchrony of the response can be determined as a function of the rate of change of a measured response to a portion of the stimulus or an event during the presentation by a plurality of audience members or the population sample.

In accordance with the invention, the input to the data processor 16 can be an N by M data matrix where N is the number of subjects and M is the number of time points during which the biological response is recorded. The data processor 16 can include one or more synchrony processing modules which receive the N by M matrix of biological response data, calculates an inverse variance across the matrix values and determines one or more standardized scores for each biological response measured and each time slot. The output will be a total integer score of the synchrony of response across subjects in time windows of W seconds width (this is a variable parameter that depends on the stimulus). In accordance with the invention, the synchrony of a given response can be determined by evaluating the rate of change of the response in a given time window or slot over the period of exposure for each participant in the test audience.

The synchrony score can be calculated according to the following steps. Step 1: Following a noise reduction process for each input channel, create a sliding window of fixed or variable width moving forward in time increments that are smaller than the window size. Step 2: In each sliding window, for each participant, compute the first derivative of one or more of the response endpoints. Step 3: Across all participants, calculate the mean (μ) and the standard deviation (σ) of the rate of change in each window. Step 4: From the above compute a score=−ln|σ−μ|. Step 5: Scale the resultant score so that all numbers are between 0 and 100. Step 7: Compute the windowed scores commensurate with the intensity score windows by averaging the sliding scores into sequential windows of fixed or variable length time-locked or event locked to the media stimulus. The score thus created is the synchrony score per unit time or per time slot or event window.

### Engagement Score

The intensity and synchrony scores may be added together to compute the moment-to-moment or event based engagement score per unit time or per time slot or event window. Depending on the nature of the test presentation and the test audience, one of the intensity and synchrony scores may be weighted relative to other. For example, for some tests it may be preferred to identify the most extreme responses and thus intensity would be weighted more heavily. Alternatively, different functions can be used to determine different forms of the engagement score. For example, multiplying intensity by synchrony creates exaggerated graphs more readable and usable in some situations such as when evaluating multiple hours of trial testimony, it may be useful to identify the most extreme examples of engagement.

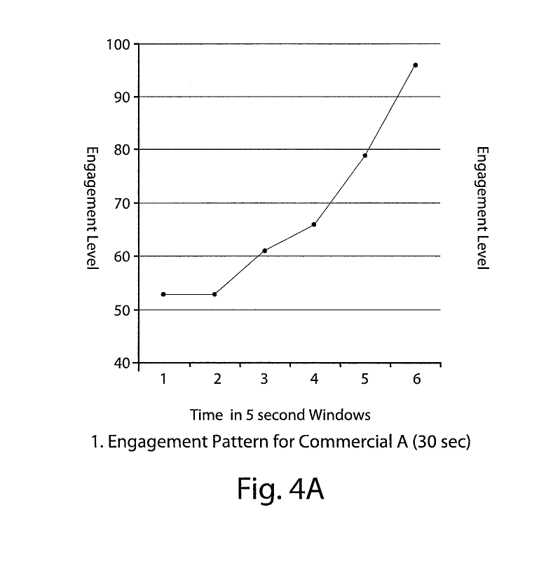

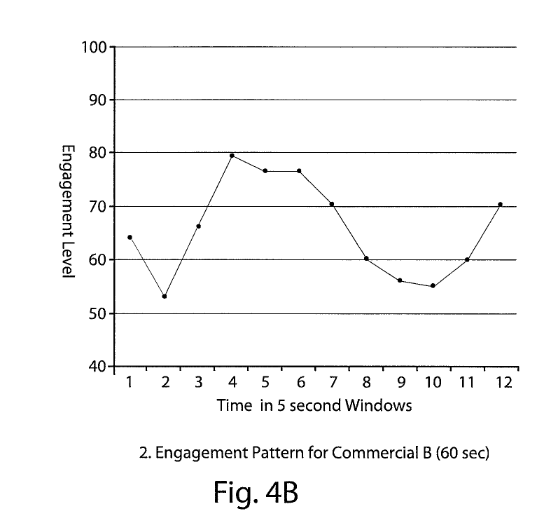

FIGS. 4A and 4B show two examples of a measure of engagement determined in accordance with the invention. The engagement diagrams were generated from a sample population audience of 20 males. FIG. 4A shows a measure or pattern of engagement for a 30 second commercial, the time period is divided into six 5 second time slots and an engagement value from 40 to 100 is determined for each time slot. As the diagram in FIG. 4A shows, the pattern of engagement increases with time. FIG. 4B shows a measure or pattern of engagement for a 60 second commercial, the time period is divided into twelve 5 second time slots and an engagement value from 40 to 100 is determined for each time slot. The commercial of FIG. 4A had three times the number of viewers who did not change the channel as compared to the commercial of FIG. 4B.

### Predictive Modeling

The system can further include a database of audience engagement to a variety of historic media or other relevant stimuli or experiences that when combined with demographic/psychographic profiles and other data relevant to the test content that allows for a prediction of the relative success of that content in a similar population. After testing an audience, various forms of the output from the described method can be used to estimate the likelihood of the success of the sensory stimulus in achieving its goal. The statistical analyses for creating predictive models can include, but are not limited to, variables related to the product or the content itself, the price of sale or cost of production of the product or content, the place of purchase or medium of experience, the cost of promotion, and/or the characteristics of the audience. For example, factors included in a model for the television industry may include but are not limited to: a) number of viewers per time slot, b) ratings of the lead-in show, c) ratings of the following show, d) mean ratings for the type of show, e) lead actor/actress popularity rating, f) time of year, g) advertising revenue, h) promotional budget for the show, and/or i) popularity of the network. Other factors may include but are not limited to characteristics of the target audience such as: a) reported liking of the show, b) psychographic characteristics (e.g., introversion vs. extroversion), c) demographic characteristics, and/or d) ability to recall or recognize elements of the show. Indicators of success can include but are not limited to how likely a population with similar characteristics is to watch the television show outside of a testing theater and/or how likely a population with similar characteristics will remember and/or purchase the products being advertised. Preferably, the more people tested (the larger the sample population) and the better characterized the population, the more likely that the model can be an accurate predictor of a larger population response. The preferred predictor model can include, but is not limited to, any of the following statistical methods: a) mixed media models, b) traditional multivariate analyses, c) hierarchical linear modeling, d) machine learning, e) regression analyses, f) Bayesian shrinkage estimators, and/or g) cluster and factor analyses.

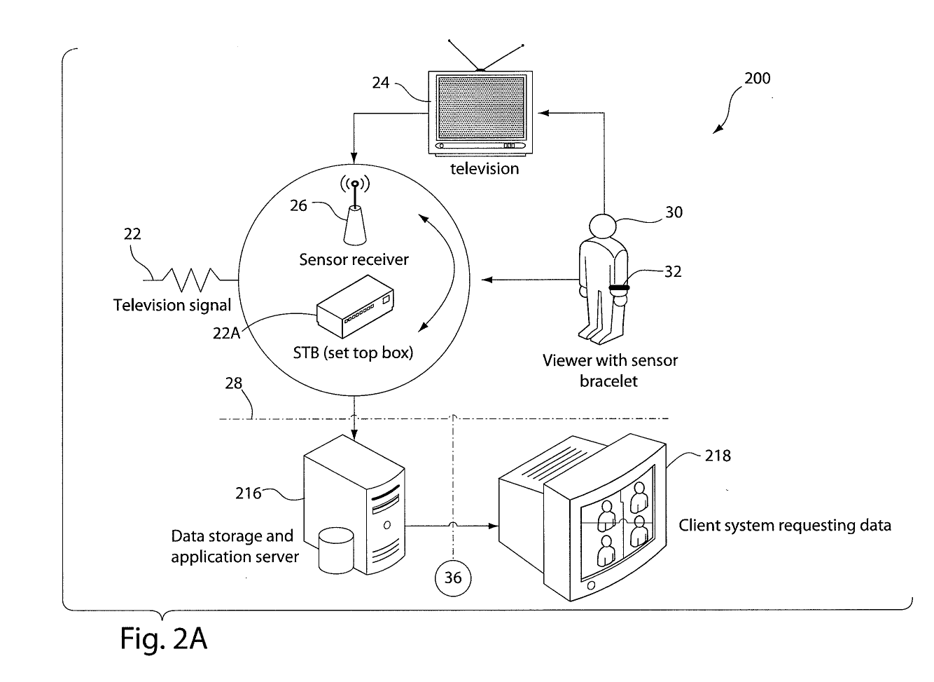

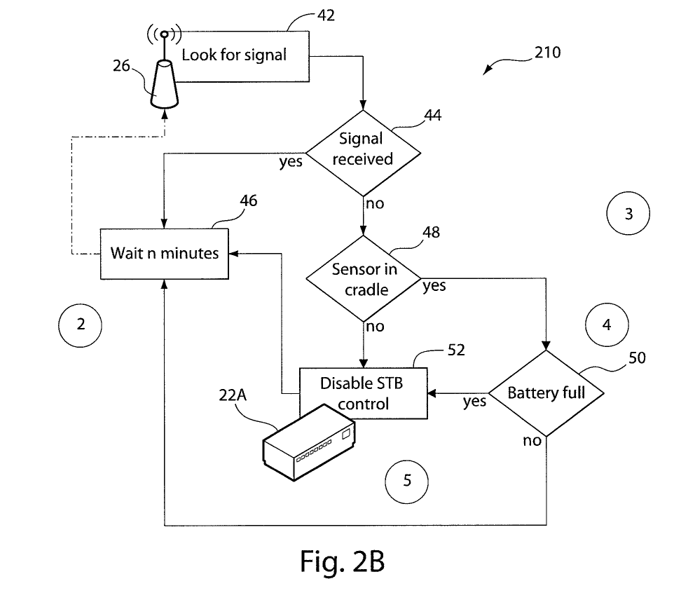

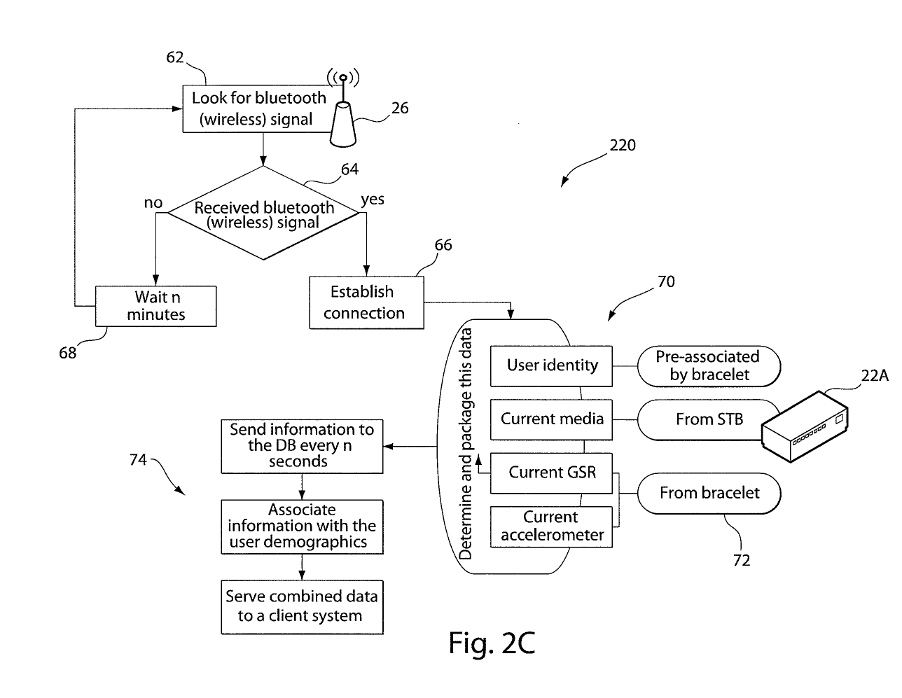

FIG. 2A shows a schematic diagram 200 of a second embodiment of the system according to the invention. In this embodiment, the media stimulus is presented via commercially available video signals 22, such as the cable TV signal and plugs into the STB 22A. In turn, the STB 22A enables programs to be displayed on the media device 24 such as a TV monitor, computer, stereo, etc. In this system, a participant 30 in viewing distance wearing a wireless sensor package in an unobtrusive form factor like a bracelet 32 interacts with the media device. In addition, bracelet 32, one or more video cameras (or other known sensing devices, not shown) can provided to measure, for example, eye tracking and facial expressions and other physical and behavioral responses. As long as that person is in basic viewing distance, the sensor receiver 26, which can be a separate unit or built into the STB 22, will receive information about that participant. The system 200 can time-stamp or event stamp the measured responses along with the unique identifier of that participant. This data can be time-stamped or events stamped with respect to the programming currently being played by the participant. This information can be sent back to a central database 216 via a transmission network 28 such as an internet connection, pager, or cellular network. The data can be combined with demographic, household, family, community, location and any other type of information potentially relevant to the end-user and processed by software using the scoring algorithm described in this application to calculate the moment-to-moment or event based pattern of engagement and compared to a database of other audience responses to the same or similar media test stimulus 36 and processed using the engagement score and/or predictive models as described above and delivered to a user-interface (11) to generate reports for distribution.

FIG. 2B shows a flow diagram 210 of the in-home compliance algorithm to improve usage of the in-home embodiment of this invention. In a household where this system can be set up, compliance can be dealt with by controlling the ability to change programming on the media device being used. The STB 22A can be programmed such that it will not function (partially or completely) if the sensor device is not being worn and is not active. If the sensors are being worn or charging, the STB can be programmed to work. If, however, the sensors are not being worn and are fully charged, the STB can be programmed not to respond fully or partially. In a partial functionality mode, only certain stations may be available, for example, public access and emergency stations. The flow chart 210 of the operation involves a receiver 26 that checks 44 to see if it is getting a signal 42 from the sensor or sensors, which is only possible if the sensor is activated and is being worn. If the receiver is getting a signal, it waits a set amount of time before starting over 46. If it does not receive a signal, the system checks whether a sensor device is being charged in the attached cradle 48. If so and the battery is not full, it also waits a set interval before checking again 50. If, however, the sensor is not active, not charging or fully charged and not being used, the STB can become inactive until the next check shows a change 52.

FIG. 2C shows one aspect of the in-home system, i.e., its ability to identify who in a given household is actually watching. The wireless technology involved in connecting the sensor with the receiver sends out a unique identifier. This identifier will be related to the data sent out in order to identify the source of the biometric data and link it to the current media stimulus. Anyone wearing a sensor but not in the defined wireless range from the receiver will not have their information tracked while outside of that range. The system will wait for a period time 68 if no wireless signal is received. If they are in the range of another receiver 62 (and STB 26) and the signal is received 62, however, their information can be tracked by that system. The flow chart 220 involves a wireless technology 26 (e.g., Bluetooth) that is used to connect the sensor device to the receiver or STB 22A. Wireless communications can be used to establish a connection 66 and transfer data between the receiver (not shown) and the STB 22A as well as to transfer data needed to determine compliance above. Once a participant is identified, information regarding that participant is collected and sent 70 to the database (DB) and processed as above 74 to generate reports for distribution.

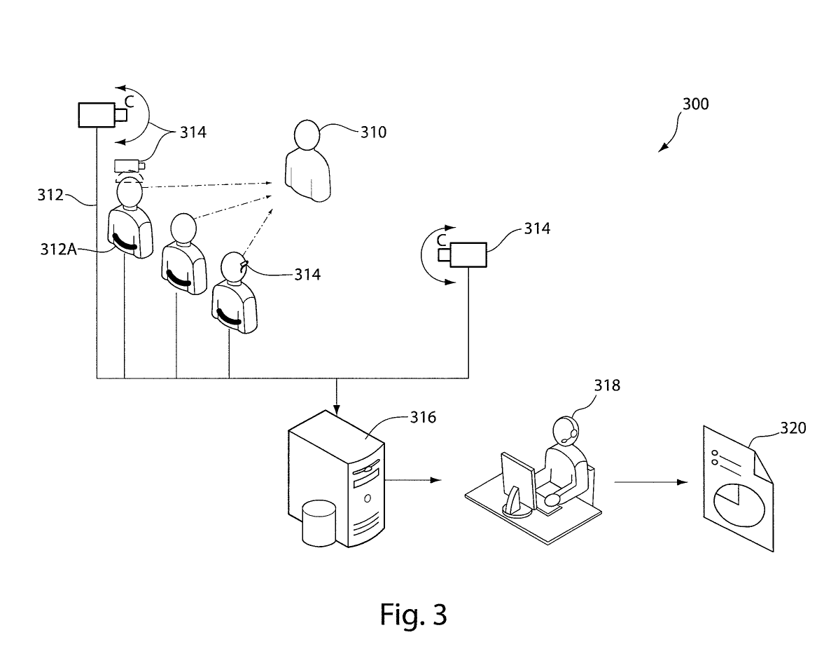

FIG. 3 shows a schematic diagram of the third embodiment of the system 300 according to the invention. In this embodiment, the sensory stimulus can be a live person 310 and the system and method of the invention can be applied to a social interaction that can include, but is not limited to, live focus group interactions, live presentations to a jury during a pre-trial or mock-trial, an interview-interviewee interaction, a teacher to a student or group of students, a patient-doctor interaction, a dating interaction or some other social interaction. The social interaction can be recorded, such as by one or more audio, still picture or video recording devices 314. The social interaction can be monitored for each individual 312 participant's biologically based responses time-locked to each other using a biological monitoring system 312A. In addition, a separate or the same video camera or other monitoring device 314 can be focused on the audience to monitor facial responses and/or eye-tracking, fixation, duration and location. Alternatively, one or more head mounted cameras 314 (for example, helmet mounted or eyeglass mounted) can be used to provide eye tracking data. The data-sources can be time-locked or event locked to each other and sent to a computer data processing device 316. The data processing device 316 can run software that includes the scoring algorithm to calculate the moment-to-moment or event based patterns of engagement and compares it to a database of other audience responses to the same or similar media test stimulus and deliver the results to a user-interface 318. The results can be processed in a predictor model as described above and interpreted and collected into a report 320 for distribution.

The algorithm can be either presented alone or plugged into a model of the relevant industry. Taking television pilot testing as an example, the model can include factors such as:

1. Typical viewers per timeslot

2. The ratings of the lead-in show

3. The ratings of the following show

4. Average ratings per genre

5. Actor popularity-QRating

6. Ratings of shows competing in the timeslot

7. Time of year

8. Promotional budget for the show

9. Demographics of the network

An example from advertising can include all of these variables but may add:

1. Flighting/repetition

2. Length of segment

3. Audience target

4. Demographics of the containing program

In accordance with an alternative embodiment of the invention, an audience (one or more individuals) is exposed to one or more an audio, visual or audio visual stimuli (such as a presentation or items of content) that are interactive and can be separated into events. An event is the exposure or interaction with a stimulus at a specific time and for a specified duration. Typically, the stimuli or presentation can be presented on a computer screen or a large format television screen and can be used in connection with a system that accepts user (audience member) input, using, for example, a mouse, a keyboard or a remote control.

In accordance with an embodiment of the invention, the system can measure one or more responses and event-lock or time-lock the measured response(s) to the portion of the stimuli (for example, the portion of the interactive presentation) being presented to or experienced by the individual audience member at the time of the response. In addition, with respect to eye tracking, the system can record the areas of interest and visual attention of each member of the audience (for which eye tracking is provided and enabled). Areas of Interest can include pre-determined target areas, sub-areas, items, creative elements or series of areas or elements within an interactive presentation (or other stimulus) used for individual or aggregated analyses of the interactive activity. Visual Attention can be measured by non-invasive eye-tracking of gaze fixations, locations, and movement for individuals and it can be aggregated for defined user groups and audience population samples.

In accordance with an embodiment of the invention, the system can record biometric measures of each member of the audience for one or more events during the interactive presentation. Biometric measures can include, but are not limited to, pupillary responses, skin conductivity and galvanic skin response, heart rate, heart rate variability, respiratory response, and brain-wave activity. Behavioral type measures can include, but are not limited to, micro and macro facial expressions, head tilt, head lean, body position, body posture, and the amount of pressure applied to a computer mouse or similar input or controlling device. Self-Report type measures can include, but are not limited to, survey responses to items such as perception of the experience, perception of ease-of-use/usability or likeability of experience, level of personal relevance to user, attitude toward content or advertising embedded in the content, intent to purchase product/game or service, and changes in responses from pre-post testing. Self-report measures can also include report of demographic information or the use of psychographic profiling.

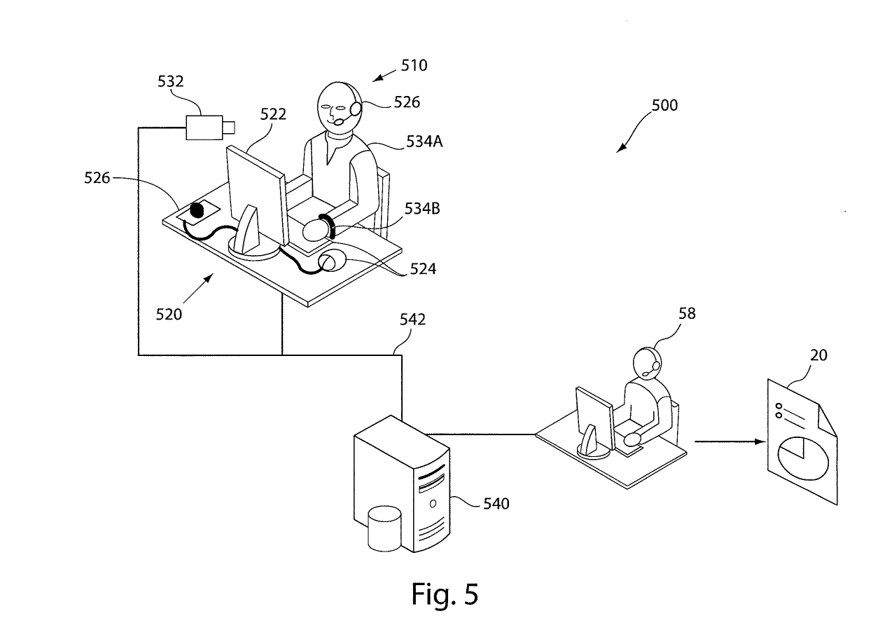

FIG. 5 shows a schematic diagram of a system 500 for exposing a member of an audience 510 to an interactive presentation provided on a computer system 520 in accordance with one embodiment of the invention. The user 510 can interact with the presentation provided on the computer screen 522 using a keyboard and/or mouse 524. Sound can be provided by a headset 526 or speakers (not shown). Additional input devices 526 can be used to receive self-report data, such as, like and dislike information in the form of a position of a dial or slider on a hand held device 526 that includes for example a potentiometer. The user can be monitored using one or more video cameras 532, one or more biometric monitoring devices 534 such as biometric sensing shirt 534A or bracelet 534B. In addition, mouse 522 can include a pressure sensor or other sensor to detect the pressure applied to the mouse buttons. These sensors 532, 534A, 534B can be used for measuring biometric responses such as eye tracking, behavioral and biologic responses. In addition, the computer 520 can be used for measuring and/or recording self-report responses, such as computer generated surveys, free text input via the keyboard 522 or audio responses via headset 526. The data processing system 540 can present the interactive presentation to the user 510 according to a predefined program or sequence and record the eye tracking data as well as other biometric response data in a manner that links the response data to presentation. The data processing system 540 can be connected to the computer system 520 by a wired or wireless network 542 to deliver presentation content to the computer system 520. The wired or wireless network 542 can also be used to deliver sensor response data to data processing system 540 for storage and further processing. Some or all of the sensor data (such as from sensors 532, 534A and 534B) and input data (such as from input devices 522, 524 and 526) can be transferred either by wire or wirelessly to the computer system 520 and further transferred to data processing system 540. Alternatively, some or all of the sensor and input data can be transferred directly to the data processing system 540 by wired or wireless network 542. Network 542 can utilize most communication technologies, including RS-232, Ethernet, WiFi, Blue Tooth and Zigbee, for example. In addition, more than one communication technology can be used at the same time, for example, network 542 can included wired components (such as, Ethernet and digital cable) and wireless components (such as, WiFi, WiMAX and Blue Tooth) to connect different sensors and computer system components to the data processing system 540. Further, the data processing system 540 can be one computer system or a cluster or group of computer systems. The response data can be linked or synchronized with the presentation (by aligning using associated timestamps or event windows), whereby the response data is associated with incremental time slots of the presentation. Alternatively, the presentation can be divided into event windows, for example, based on the specific tasks or activities that are included in the interactive presentation and the response data can be associated with event windows associated with specific tasks or portions of a task. Each task or activity can have one or more event windows associated with it and each event window can have the same or a different duration of time.

Similar to the other embodiments disclosed herein, the intensity and synchrony indices of the time slots or event windows can be determined for one or more individuals and the individual intensity and synchrony indices can be aggregated for the sample population of the interactive activity in order to determine the level of engagement or engagement index for the interactive presentation or one or more tasks or activities within the presentation.

In accordance with one embodiment of the invention, the eye tracking, behavioral and other biometric measures (either individually or in combination) can be presented to the user to create conscious awareness of these responses and improve the accuracy and utility of the self-report measures. The self report measures can be used in addition to the intensity, synchrony and engagement metrics to evaluate the audience responses to the presentation or activity. The user can be exposed to the interactive presentation and then the user can be exposed to the interactive presentation (or specific portions of the presentation) a second time and provided with information or representative information of their eye tracking, behavioral and other biometric responses and then the user is presented with survey questions (or questionnaires), exposed to one-on-one debriefings or interviews, or involved in qualitative focus groups. Alternatively, inquiries can be made to the user as they view the presentation a second time along with their responses to the presentation.

In addition to synchrony, intensity and engagement, other measures or indices can be determined from the response data collected that can be used to evaluate the users' and the group's responses to the presentation. These measures or indices include Biometric Cognitive Power, Biometric Emotive Power and Visual Impact. For each presentation, task, process or experience, one or more Flow, Appeal and Engagement indices can also be determined to aid in the assessment and predictability of the overall audience response. Each of the measures or indices can be determined or computed using a computer system according the invention using one or more methods according to the invention. The preferred embodiment, one or more of the measures or indices can be determined by a computer software module running on a computer system according to the invention. The computer software module can be a stand alone program or component of a larger program and can include the ability to interact with other programs and/or modules or components.

In accordance with one embodiment of the invention, computer system can include a computer software module that records, by storing in memory of the computer system, the biometric and other data produced by the biometric sensors and video cameras. The stored biometric and other data can be associated with a point in time within the time duration of the presentation or an event window of an activity that serves as the stimulus. This can be accomplished by storing one or more data values paired with or linked to a time value or using a database that associates one or more stored data values with one or more points in time. After the presentation has ended or the activity is completed, software running on the computer system can process the stored biometric and other data to determine the various measures and indices. Alternatively, the stored data can be transferred to another computer system for processing to determine the various measures and indices.

The Biometric Cognitive Power index for an event window (or a time slot or time window) can be determined as a function of the portion of the event time (duration or frequency) during an interactive task, process or experience where the cognitive response (value, amplitude or rate of change of value or amplitude) such as, the pupillary response, is above a predefined threshold (for example, above or below the mean or average response by k * standard deviation, where k can be, for example, 0.5, 1.0, 1.5). In other embodiments, other measures of cognitive response can be used as an alternative to or in addition to pupillary response, such as EEG or brain wave activity.

Biometric Cognitive Power index (e) for an event e, can be determined as the sum of the number of time instants ti (or the portion or percentage of time) in the first T seconds of each subject's experience (which is referred to as the subject's analysis-duration T) where the cognitive response measured is above the predefined threshold and averaged across all subjects viewing the same experience/stimulus.

For example, Biometric Cognitive Power(e)=Average[across all subjects s](sum of (cognitive_response (s,ti))

where ti<T and cognitive response (pupil_response)>specified threshold

In one embodiment of the invention, the analysis-duration T can be set to the first 5 seconds of the subjects' experience of the event. In other embodiments, it can be, for example, set between 5-10 seconds. In other embodiments, it can be set to one-half or one-third of the event duration or time window.

In one embodiment of the invention, a time instant ti can be the sampling rate of the system for the biometric sensor, for example, 20 msec. In other embodiments, other units of time can be used, such as 0.10 sec. and 0.01 sec.

Where, in this example, the cognitive response measured is a pupillary response function. The function, pupil_response (s, ti) can be the response of subject s during event window e at time instant ti, if the response differs from the average response for subject s on event e by more than k* standard deviation, where k can be an analysis-specific threshold or parameter, fore example, between 0.5 and 1.5. The length of the analysis-duration can be specific to each stimulus image, event or scene of the presentation.

In accordance with one embodiment of the invention, the analysis-duration T can be determined as one half to one-third the time needed for an average individual to process the information shown in the image, event or scene of the presentation. For instance, if the presentation consists primarily of a textual document or print material then analysis-duration T can be, for example, set in the range of 15-45 seconds and begin at the start of the time window or event window or within, for example, the first 15 seconds of the time or event window. If the image, event or scene consists primarily of visual objects/drawings as in a print ad (with very little text information), then the analysis-duration T can be set in the range of 5 to 10 seconds. In an alternative embodiment of the invention, the analysis-duration can be set to the first 5 seconds of an event window or time window. In other embodiments, the analysis-duration T, can be any unit of time less than or equal to the event window or time window and can begin at any point during the event window or the time window. For interactive activities, for example shopping, the event window can be a unit of time during which the audience member selects an item for purchase, makes a purchase or returns an item and the analysis duration T can begin approximately at the point in time when the audience member selects an item for purchase, make a purchase or returns an item.

In accordance with one embodiment of the invention, the Biometric Cognitive Power index determination can be implemented in a computer program or computer program module that accesses biometric data stored in memory of a computer system, receives the data from another program module or receives it directly from biometric sensors. The data can be real time data or data that was previously captured from one or more audience members and stored for later processing.

In accordance with one embodiment of the invention, the parameters, including k and the analysis-duration T can be computed using predictive models described in any of the data mining books described herein, by utilizing outcome variables such as a subjects' (or audience member's) behavior (e.g., purchase/return of a product described in the stimulus or event). The data mining books include: Larose, Daniel T., Data Mining Methods and Models, John Wiley & Sons, Inc., 2006; Han, Micheline Kamber Jiawei, Data Mining: Concepts and Techniques, Second Edition (The Morgan Kaufmann Series in Data Management Systems), Elsevier, Inc., 2006; Liu, Bing, Web Data Mining: Exploring Hyperlinks, Contents, and Usage Data (Data-Centric Systems and Applications), Springer-Verlag, 2007; and Berry, Michael J. A. and Linoff, Gordon S., Data Mining Techniques: For Marketing, Sales, and Customer Relationship Management, John Wiley & Sons, Inc., 1997; all of which are herein incorporated by reference in their entirety.

For visual stimuli, such as images, we can, for example, represent the 2-dimensional screen area as composed of a grid of size m-by-n cells or pixels. The m and n values will depend on the parameters of the visual stimulus and the computer or TV screen on which the visual stimulus is presented and can be the pixel resolution of the presentation screen or determined as a function of the pixel resolution of the presentation screen. Typically, m-by-n will be 1280-by-1024 or 640-by-480. In on embodiment of the invention, the visual screen can be a 1280-by-1024 grid of pixels and the stimulus grid can be represented by a matrix of grid cells, for example as 640-by-512 (by defining a grid cell as a 2×2 matrix of pixels).

Gaze location can be defined as a set of grid-cells that are determined to be the focus of an audience member's gaze and represent the set of grid cells (0−(m*n)) that an audience member looked at during a time or event window. If the audience member focused on one grid cell, the gaze location would be one the grid cell, whereas, if the audience member focused on more than one grid cell, the gaze location would be a set of grid cells or a function of the set of grid cells (such as the grid cell or set of contiguous grid cells that were the focus for the longest time). Where a grid cell is defined as more than one pixel, audience member focus on any of the pixels in the grid cell is considered gaze on the location of the grid cell. A gaze location can be used to identify a contiguous area using a set of grid cells on the screen. Alternatively, a gaze location can also represent a group of such contiguous areas, each area being disjoint from one another.

A Biometric Cognitive Map can be produced by plotting the areas of individual or aggregated group gaze fixation as a function of a biometric cognitive power index (where the duration or frequency of cognitive response are above a threshold level) and the gaze locations on the presentation (or image, event or scene therein) corresponding to the cognitive power index when the stimulus has a visual component, such as an image or a video. A biometric cognitive map can be used to identify the areas of a presentation that are associated with higher levels of responses indicative of high levels of cognitive activity. Specifically, a biometric cognitive map represents the gaze locations or aggregated regions of the locations on the visual portion of the stimulus when the cognitive response for a subject differs from its mean by k*standard deviation, for example, where k can be between 0.5 and 1.5 during the analysis-duration for the subject's experience. The gaze locations can be aggregated either across temporal instants for each subject (e.g., a subject ‘s’ looking at a location at instants “h” and “h+5”) within the analysis-duration, or across different subjects looking at the locations within the analysis-duration of their experience. A variety of clustering algorithms, such as those described in data mining books disclosed herein, can be employed to create aggregated regions or clusters from a set of specific gaze locations.

In accordance with one embodiment of the invention, the Biometric Cognitive map can be generated by a computer program, computer program module or a set of computer program modules that access biometric cognitive power index data and gaze fixation data that was stored in memory of a computer system, received from another program module or received directly from biometric sensors and the eye tracking system. The data can be real time data or data that was previously captured and stored from one or more audience members.

In accordance with one embodiment of the invention, a biometric cognitive plotarea can be determined by first plotting gaze locations in a cognitive map, such as for a specific time or event window, then creating clusters or aggregated regions and determining the area or relative area of clusters.

In accordance with one embodiment of the invention, the system, in accordance with the method of the invention, can plot the gaze locations that correspond to significant cognitive responses (responses that meet or exceed a threshold) in a biometric cognitive map for a stimulus (or an event) for all subjects exposed to the stimulus for a period more than the analysis-duration. This can, for example, be implemented in a computer program, a computer program module or set of computer program modules. The gaze locations can be plotted only when the cognitive response for a subject is, for example, above or below (i.e., differs from) the subject's mean response by k*std_deviation, where, for example, k can be between 0.5 and 1.5. If the response is above the mean, the location can be termed a location of high cognitive response and the locations can be considered high cognitive locations. If the response is below the mean response, the location can be termed a location of low cognitive response and the locations can be considered low cognitive locations.

In addition, adjacent high locations and/or adjacent low locations can be combined based on their proximity (distance to each other) using well known clustering algorithms. Examples of clustering algorithms are disclosed in the data mining books disclosed herein.

In accordance with one embodiment of the invention, the clustering can be accomplished as follows:

For each grid cell identifying a high or low location, expand the set of grid cells to include all its neighboring grid cells, 5 grid cells in all directions (i.e., expanding by a circle of radius of 5 centered at the grid cell) in the cluster. Alternate radii of 10-15 grid cells may also be employed. The cluster for a set of grid cells of a kind (high or low) can thus include any ‘unfilled gaps’ (unselected grid cells in the area) and identify one or more contiguous ‘geometric regions’ in the cognitive map. The low cognitive clusters in a cognitive map will cluster the low cognitive locations and the high cognitive clusters in a cognitive map will cluster the high cognitive locations. The clustering algorithm can be applied iteratively starting with a single grid cell (or pixel) or set of contiguous grid cells (or pixels) and repeated until a predetermined number of clusters are defined.

The biometric cognitive plotarea can have low and high cognitive clusters identified on or defined for a cognitive map. The system, according to the method of the invention, can determine the biometric cognitive plotarea by determining the total area of the high and/or the low cognitive clusters. The biometric cognitive plotarea can be measured in terms of the number of pixels or grid cells in a cluster or group of clusters, or as a proportion (or percentage) of the total area of the presentation screen or a portion of the presentation screen (such as, a quadrant or a region).

In accordance with one embodiment of the invention, the Biometric Cognitive plotarea can be determined using a computer program, computer program module or a set of computer program modules that access biometric data and gaze fixation data, and/or intermediate data constructs (such as, the Biometric Cognitive Power index), that were stored in memory of a computer system, received from another program module or received directly from biometric sensors and the eye tracking system. The data can be real time data or data that was previously captured and stored from one or more audience members.

The Biometric Emotive Power index for an event window (or a time slot or time window) can be determined as a function of the portion of the event time (duration or frequency) during an interactive task, process or experience where the emotive response (value, amplitude or rate of change of value or amplitude) such as one or more of skin conductance, heart rate, and respiratory responses, is above a predefined threshold (for example, above or below the mean or average response by k * standard deviation, where k can be, for example, 0.5, 1.0, 1.5). In other embodiments, other measures of emotive response can be used as an alternative to or in addition to skin conductance, heart rate and respiratory responses, such as brain wave activity.

Biometric Emotive Power index (e) for an event e, can be determined as the sum of the number of timeinstants ti (or the portion or percentage of time) in the first T seconds of each subject's experience (which is referred to as the subject's analysis-duration T) where the emotive response measured is above the predefined threshold and averaged across all subjects viewing the same experience/stimulus.

For example, Biometric Emotive Power(e)=Average[across all subjects s](sum of (emotive_response(s,ti))

where ti<T and emotive response (skin_conductance_response)>specified threshold

In one embodiment of the invention, the analysis-duration T can be set to the first 5 seconds of the subjects' experience of the event. In other embodiments, it can be, for example, set between 5-10 seconds. In other embodiments, it can be set to one-half or one-third of the event duration or time window.

In one embodiment of the invention, a timeinstant ti can be the sampling rate of the system for the biometric sensor, for example, 20 msec. In other embodiments, other units of time can be used, such as 0.10 sec. and 0.01 sec.

Where, in this example, the emotive response measured is a skin conductance response function. The function, skin_conductance_response (s, ti) can be the response of subject s during event window e at timeinstant ti, if the response differs from the average response for subject s on event e by more than k* standard deviation, where k can be an analysis-specific threshold or parameter, fore example, between 0.5 and 1.5. The length of the analysis-duration can be specific to each stimulus image, event or scene of the presentation.

In accordance with one embodiment of the invention, the analysis-duration T can be determined as one half to one-third the time needed for an average individual to process the information shown in the image, event or scene of the presentation. For instance, if the presentation consists primarily of a textual document or print material then analysis-duration T can be, for example, set in the range of 15-45 seconds and begin at the start of the time window or event window or within, for example, the first 15 seconds of the time or event window. If the image, event or scene consists primarily of visual objects/drawings as in a print ad (with very little text information), then the analysis-duration T can be set in the range of 5 to 10 seconds. In an alternative embodiment of the invention, the analysis-duration can be set to the first 5 seconds of an event window or time window. In other embodiments, the analysis-duration T, can be any unit of time less than or equal to the event window or time window and can begin at any point during the event window or the time window. For interactive activities, for example shopping, the event window can be a unit of time during which the audience member selects an item for purchase, makes a purchase or returns an item and the analysis duration T can begin approximately at the point in time when the audience member selects an item for purchase, make a purchase or returns an item.

In accordance with one embodiment of the invention, the Biometric Emotive Power index determination can be implemented in a computer program or computer program module that accesses biometric data stored in memory of a computer system, receives the data from another program module or receives it directly from biometric sensors. The data can be real time data or data that was previously captured from one or more audience members and stored for later processing.

In accordance with one embodiment of the invention, the parameters, including k and the analysis-duration T can be computed using predictive models described in any of the data mining books described herein, by utilizing outcome variables such as a subjects' (or audience member's) behavior (e.g., purchase/return of a product described in the stimulus or event).

For visual stimuli, such as images, we can, for example, represent the 2-dimensional screen area as composed of a grid of size m-by-n cells or pixels. The m and n values will depend on the parameters of the visual stimulus and the computer or TV screen on which the visual stimulus is presented and can be the pixel resolution of the presentation screen or determined as a function of the pixel resolution of the presentation screen. Typically, m-by-n will be 1280-by-1024 or 640-by-480. In on embodiment of the invention, the visual screen can be a 1280-by-1024 grid of pixels and the stimulus grid can be represented by a matrix of grid cells, for example as 640-by-512 (by defining a grid cell as a 2×2 matrix of pixels).

Gaze location can be defined as a set of grid-cells that are determined to be the focus of an audience member's gaze and represent the set of grid cells (0−(m*n)) that an audience member looked at during a time or event window. If the audience member focused on one grid cell, the gaze location would be one the grid cell, whereas, if the audience member focused on more than one grid cell, the gaze location would be a set of grid cells or a function of the set of grid cells (such as the grid cell or set of contiguous grid cells that were the focus for the longest time). Where a grid cell is defined as more than one pixel, audience member focus on any of the pixels in the grid cell is considered gaze on the location of the grid cell. A gaze location can be used to identify a contiguous area using a set of grid cells on the screen. Alternatively, a gaze location can also represent a group of such contiguous areas, each area being disjoint from one another.

A Biometric Emotive Map can be produced by plotting the areas of individual or aggregated group gaze fixation as a function of a biometric emotive power index (where the duration or frequency of emotive response are above a threshold level) and the gaze locations on the presentation (or image, event or scene therein) corresponding to the emotive power index when the stimulus has a visual component, such as an image or a video. A biometric emotive map can be used to identify the areas of a presentation that are associated with higher levels of responses indicative of high levels of emotive activity. Specifically, a biometric emotive map represents the gaze locations or aggregated regions of the locations on the visual portion of the stimulus when the emotive response for a subject differs from its mean by k*standard deviation, for example, where k can be between 0.5 and 1.5 during the analysis-duration for the subject's experience. The gaze locations can be aggregated either across temporal instants for each subject (e.g., a subject ‘s’ looking at a location at instants “h” and “h+5”) within the analysis-duration, or across different subjects looking at the locations within the analysis-duration of their experience. A variety of clustering algorithms, such as those described in data mining books disclosed herein, can be employed to create aggregated regions or clusters from a set of specific gaze locations.

In accordance with one embodiment of the invention, the Biometric Emotive map can be generated by a computer program, computer program module or a set of computer program modules that access biometric emotive power index data and gaze fixation data that was stored in memory of a computer system, received from another program module or received directly from biometric sensors and the eye tracking system. The data can be real time data or data that was previously captured and stored from one or more audience members.

In accordance with one embodiment of the invention, a biometric emotive plotarea can be determined by first plotting gaze locations in a emotive map, such as for a specific time or event window, then creating clusters or aggregated regions and determining the area or relative area of clusters.

In accordance with one embodiment of the invention, the system, in accordance with the method of the invention, can plot the gaze locations that correspond to significant emotive responses (responses that meet or exceed a threshold) in a biometric emotive map for a stimulus (or an event) for all subjects exposed to the stimulus for a period more than the analysis-duration. This can, for example, be implemented in a computer program, a computer program module or set of computer program modules. The gaze locations can be plotted only when the emotive response for a subject is, for example, above or below (i.e., differs from) the subject's mean response by k*std_deviation, where, for example, k can be between 0.5 and 1.5. If the response is above the mean, the location can be termed a location of high emotive response and the locations can be considered high emotive locations. If the response is below the mean response, the location can be termed a location of low emotive response and the locations can be considered low emotive locations.

In addition, adjacent high locations and/or adjacent low locations can be combined based on their proximity (distance to each other) using well known clustering algorithms. Examples of clustering algorithms are disclosed in the data mining books disclosed herein.

In accordance with one embodiment of the invention, the clustering can be accomplished as follows:

For each grid cell identifying a high or low location, expand the set of grid cells to include all its neighboring grid cells, 5 grid cells in all directions (i.e., expanding by a circle of radius of 5 centered at the grid cell) in the cluster. Alternator radii of 10-15 grid cells may also be employed. The cluster for a set of grid cells of a kind (high or low) can thus include any ‘unfilled gaps’ (unselected grid cells in the area) and identify one or more contiguous ‘geometric regions’ in the emotive map. The low emotive clusters in an emotive map will cluster the low emotive locations and the high emotive clusters in an emotive map will cluster the high emotive locations. The clustering algorithm can be applied iteratively starting with a single grid cell (or pixel) or set of contiguous grid cells (or pixels) and repeated until a predetermined number of clusters are defined.

The biometric emotive plotarea can have low and high emotive clusters identified on or defined for an emotive map. The system, according to the method of the invention, can determine the biometric emotive plotarea by determining the total area of the high and/or the low emotive clusters. The biometric emotive plotarea can be measured in terms of the number of pixels or grid cells in a cluster or group of clusters, or as a proportion (or percentage) of the total area of the presentation screen or a portion of the presentation screen (such as, a quadrant or a region).

In accordance with one embodiment of the invention, the Biometric Emotive plotarea can be determined using a computer program, computer program module or a set of computer program modules that access biometric data and gaze fixation data, and/or intermediate data constructs (such as, the Biometric Emotive Power index), that were stored in memory of a computer system, received from another program module or received directly from biometric sensors and the eye tracking system. The data can be real time data or data that was previously captured and stored from one or more audience members.

The eye tracking system can monitor the gaze fixation of each user, on a moment by moment basis or an event basis. The gaze fixation data can be used to identify elements, areas or regions of interest, including areas that the user or a group of users (that make up the sample audience) spent more time looking at than other areas of a presentation or correspond to or are associated with higher cognitive or emotive responses than other areas. The system can analyze the eye tracking and the response data and determine or calculate the plotarea of the region, area or element within the presentation that corresponds to a response or combination of responses. The plotarea can define the peripheral boundary of an area or region that is of interest.

Using the eye tracking response data and the biometric response data, one or more biometric cognitive maps and biometric emotive maps can be generated and the biometric cognitive and emotive plotarea for each cognitive and emotive map can also be determined. In accordance with one embodiment of the invention, the Cognitive and Emotive Visual Coverage indices for a category of stimuli (for example, products) can be determined as function of the biometric cognitive and emotive plotareas. In one embodiment, the Visual Coverage index can be determined as function of the areas of the presentation that are associated with either high or low (cognitive or emotive) response and the total area of the presentation screen or the presentation on the screen.

High Cognitive Visual Coverage Index=High Cognitive plotarea/Total Area

Where the High Cognitive plotarea is the sum of the area of all the high cognitive clusters for the stimulus and the Total Area is the total area of the presentation gaze area (where the presentation occupies less than the whole screen) or the screen.

High Emotive Visual Coverage Index=High Emotive plotarea/Total Area

Where the High Emotive plotarea is the sum of the area of all the high emotive clusters for the stimulus and the Total Area is the total area of the presentation gaze area (where the presentation occupies less than the whole screen) or the screen.

Low Cognitive Visual Coverage Index=Low Cognitive plotarea/Total Area

Where the Low Cognitive plotarea is the sum of the area of all the low cognitive clusters for the stimulus and the Total Area is the total area of the presentation gaze area (where the presentation occupies less than the whole screen) or the screen.

Low Emotive Visual Coverage Index=Low Emotive plotarea/Total Area

Where the Low Emotive plotarea is the sum of the area of all the low cognitive clusters for the stimulus and the Total Area is the total area of the presentation gaze area (where the presentation occupies less than the whole screen) or the screen.

Where at least one biometric cognitive map and at least one biometric emotive map are generated, cognitive coverage indices (high and low) and emotive visual coverage indices (high and low) can be determined for each task, process, experience or event.

In accordance with one embodiment of the invention, a Visual Impact index (or area) can be determined as function of the cognitive and emotive coverage indices. The High Visual Impact index (or area) for a stimulus or category of stimuli (or products) can be determined as the average or the sum of the emotional and cognitive coverage indices.

For example, in accordance with one embodiment of the invention:

The High Visual Impact index (or area) for a stimulus or category of stimuli (or products) can be, for example, determined as:

(High Emotional Visual Coverage Index+High Cognitive Visual Coverage Index)

The Low Visual Impact index (or area) for a stimulus or category of stimuli (or products) can be, for example, determined as:

(Low Emotional Visual Coverage Index+Low Cognitive Visual Coverage Index)

In accordance with an embodiment of the invention, each of the computed biometric measures described herein, such as, intensity, synchrony, engagement, emotional power index, cognitive power index, emotional coverage index, biometric coverage index and visual impact for a stimulus can be used to predict or estimate the success rate of the stimulus on a stand-alone or on a comparative basis to other stimuli. The success can be measured by the external response measures of the general or target audience outside the test facility to the content, product or brand represented in the stimuli. The external response measures can include but is not limited to the number of viewers watching, downloading and/or storing, or skipping/forwarding the stimulus (overall viewing characteristics), the number of comments or amount of buzz that the stimulus or the content referred to in the stimulus generates in offline or online (internet) forums, social networks, communities and/or markets, the number of views of the stimulus (by audience members) in offline or online (internet) forums, social networks, communities and markets, the average rating for the stimulus by the audience, the overall adoption rate (the volume of product sales) by target audience etc.

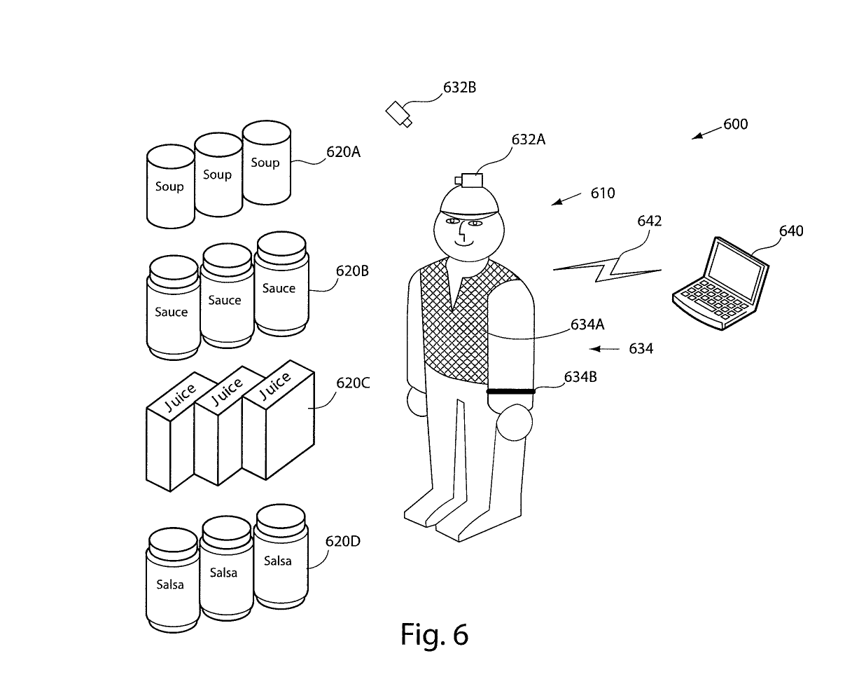

In accordance with one embodiment of the invention 600, as shown in FIG. 6, a sample population of shoppers 610 (individuals seeking to purchase a specific product or product type) can be studied by exposing them to an active or passive presentation which includes a set of products 620 or products of a specific type. For example, different types and/or brands of Soups 620A, Sauces 620B, Juices 620C, and Salsas 620D can be presented, such as on a store shelf. Each shopper 610 can be monitored while actually shopping in a store for (or being presented with a simulated environment or diagram of a store or supermarket shelf showing) different products, for example, juices, salsas, sauces or soups), all by the same or a different company (same brand or different companies and brands) and asked to select one or more for purchase, for example, by taking the product off the shelf or selecting with a mouse or dragging an icon to a shopping cart. Where the shopper is actually shopping in a store, the shopper can be fitted with a camera that is directed to show what the shopper is looking at, for example a helmet mounted camera 632A, or a camera mounted on eye glasses worn by the shopper (not shown). Thus, the camera 632A can show what the shopper 610 is looking at during any given time slot or event window. In addition, the shopper can be monitored using one or more biometric monitoring devices 634 worn by the shopper during the experience, such as biometric sensing shirt 634A or bracelet 634B. Additional cameras 632B can be provided (either mounted or hand held) in the area of the store that the shopper is viewing to provide pupillary response data. The response data can be stored in the monitoring devices 634 (or one or more memory devices associated with one or more of the monitoring devices) worn by the user, or transferred by wire (not shown) or wirelessly over network 642 to data processing system 640, shown as a portable computer, although a desktop computer or group of computers, can be used as well. Depending on the type of network used, the data processing system can located in any location that can be connected to the network 642, such as within the store, across the city or across the country. The network 642 can be made up of several communication channels using one technology or a combination of technologies (Ethernet, WiFi, WiMAX, Blue Tooth, ZigBee, etc.). Where the data is stored in the monitoring devices (or one or more memory devices associated with one or more of the monitoring devices) a network 642 can be used to transfer the data to the data processing system 640 after the task or presentation or a set of tasks or presentation is paused or completed. Alternatively, the stored data can be transferred to the data processing system 640 by direct wire connection (not shown) as well. As described here, the data processing computer can process the sensor and camera data to generate the various indices described herein.

Alternatively, the shopper can be fitted only with a helmet mounted camera 632A or eye glass mounted camera (not shown) and sent on a shopping spree. The shopper can be presented with a video of the shopping experience on a computer, television or video screen while being monitored using a system according to an embodiment of the invention, such as shown in FIG. 5. Thus, an eye tracking system 532 and a combination of biometric and behavioral sensing devices 534A, 534B and input devices 534, 526, 528 can be used to monitor response data associated with the activity and transfer the response data to the data processing system 540 for further processing. Alternatively, the shopper can go shopping in a simulated or virtual reality environment.

In each of these presentations, as the shopper 610 views each individual product 620A, 620B, 620C, 620D on the shelf, the eye tracking system can determine which product is being focused on and the biometric responses of the user can be recorded at that time. The response data, when it is stored, can be associated with a time mark, frame number, or an arbitrary index mark or number of the presentation. In one embodiment, the system records the responses on 20 ms intervals, but longer or shorter intervals can be used depending on the various constraints and requirements of the system, for example, the speed and size of the data storage system and the response characteristics of the sensor systems being used and the desired resolution. In accordance with one embodiment of the invention, the presentation can provide running time or a frame by frame index or time that allows the system to associate the response data with a specific point in time, typically offset from the beginning of the presentation or allows the response data to be associated with a specific frame number or time index associated with a specific frame.

In other embodiments of the invention, the presentation can be marked or associated with predefined event windows that start at a predefined time or frame of the presentation and extend for a predefined duration of time. The time between event windows does not have to be constant and the duration of an event window can be the same or different from one event window to the next. In one embodiment, an event window begins when a user is presented with a screen display which involves the user in an interactive presentation, task or activity and extends for a duration of five (or in some cases, up to ten) seconds. During the five (or ten) second window, the eye tracking, behavior and biometric response data can be collected on 20 ms intervals, providing up to 250 (or 500 for 10 second duration) data points from each sensor for the event window. Some sensors may not provide data at the same frequency and the system can determine a single elemental value for each response measured on an event window by event window basis. The single elemental value for the event window can, for example, be determined as function of the mean, median or mode of the response data received during the time period corresponding to the event window.

In accordance with one embodiment of the invention, the above metrics can be used to analyze the engagement and visual impact of various interactive and passive presentations for various audiences. It has been found that the high visual impact index correlates well with the biometric non-visual intensity (using non-visual, biometric responses, e.g., heart rate, skin conductivity, respiration) at the time of purchase or product selection whereas the low visual impact index correlates well with the biometric non-visual intensity at the time of returning products back on product shelf.

Table 1 below shows sample data and can be used to demonstrate the correlation between behavior and biometric intensity indices and visual impact indices determined according to the embodiments of the invention. The results in Table 1 show the intensity indices and the visual impact indices from response data for a set of shopping tasks or activities where a shopper was asked to select juice, salsa, sauce and soup for purchase.

TABLE 1

| Activity | Non-Visual | Intensity | Visual Impact | Visual | Visual Impact |
|---|---|---|---|---|---|
| Category | Intensity | Ranking | Category | Impact | Ranking |
| Juice-Purchase | 12.80 | 2 | Juice-HighVisual | 3.14 | 5 |
| Juice-Return | 14.25 | 3 | Juice-LowVisual | 2.75 | 4 |
| Salsa-Purchase | 14.25 | 3 | Salsa-HighVisual | 0.73 | 1 |
| Salsa-Return | 26.70 | 7 | Salsa-LowVisual | 4.17 | 7 |
| Sauce-Purchase | 16.16 | 5 | Sauce-HighVisual | 4.94 | 8 |
| Sauce-Return | 10.00 | 1 | Sauce-LowVisual | 2.12 | 2 |
| Soup-Purchase | 14.40 | 4 | Soup-HighVisual | 2.32 | 3 |
| Soup-Return | 17.15 | 6 | Soup-LowVisual | 3.25 | 6 |

In Table 1 above, the Activity Category is the behavior (activity or task) being evaluated, the Non-Visual Intensity is a measure of the Intensity index for the biometric response data, the Intensity Ranking is the overall ranking of the 8 categories of the intensity data. For each activity, purchase (selecting a product from a supermarket shelf) or return (returning a selected product to the shelf), the visual impact of the activity was also determined and based on the predefined threshold, the visual impact was categorized as high or low. The last column shows the overall ranking for the visual impact indices for the shopping activity.

The data above was correlated, a correlation value less than 0.3 indicates a small or not significant correlation, a correlation value above 0.3 and less than 0.5 indicates a medium or moderate correlation and a correlation value above 0.5 indicates a high or significant correlation. For all the activity categories in Table 1, the correlation between the Non-Visual Intensity indices and the Visual Impact indices is 0.52. For only the Juice related activities in Table 1, the correlation between the Non-Visual Intensity indices and the Visual Impact indices is 0.55. For only the Sauce and Soup related activities in Table 1, the correlation between the Non-Visual Intensity indices and the Visual Impact indices is 0.65. Correlations were also determined based on the ranking data. For all the activity categories in Table 1, the correlation between the Non-Visual Intensity ranking and the Visual Impact ranking is 0.7. For only the Juice related activities in Table 1, the correlation between the Non-Visual Intensity ranking and the Visual Impact ranking is 0.8. For only the Sauce and Soup related activities in Table 1, the correlation between the Non-Visual Intensity ranking and the Visual Impact ranking is 0.785. If the data from Table 1 is separated into purchase (or selection) activities and return activities, for the Purchase Activity, the correlation between the Intensity indices and the High Visual Impact indices is 0.49 and for the Return Activity, the correlation between the Intensity indices and the low Visual Impact indices is 0.99.

The Flow index of a task, process or experience can be determined as a function of measures of task (process, or experience) completion indices, efficiency indices and frustration indices and can include self-report and biometric responses to further weight or adjust the completion index, efficiency index and frustration index. In accordance with one embodiment of the invention, the Flow Index can be determined by the equation:

Flow Index=(Completion Index+Efficiency Index)−Frustration Index

The Completion index can be determined as a function of the percentage of a test group of individual users that completed a task, process or experience and one or more metrics relating to the time to completion, such as the mean time to completion and the standard deviation over the test group. Tasks or processes that have a high percentage of completion can be given a high completion index, and where two or more tasks have a similar percentage of completion, the tasks with shortest time to completion or the smallest deviation in time to completion can be weighted higher than the others.

If compl-time(T) represents the mean time for completion of task T, then

Completion index for task T can be defined as a z-score, such as (compl-time(T)−average of (compl-time(Ti)))/Standard_deviation(compl_time(Ti)).

Note that other functions for the Completion index of task T can also be derived, using predictive models described in the data mining books described herein, by relating the completion times to outcome variables such as testgroup's behavior (e.g., like/dislike of a task T). Specific techniques that could be utilized include regression analysis for finding a relationship between completion times and outcome variables and using completion index as an indicator of the outcome variable.

The Efficiency index can be determined as a function of gaze fixation and duration over a series of one or more target areas of interest (such as along a task path). The Efficiency index can be weighted by a self-report measure of ease-of-use and user experience. Tasks or processes that have a higher percentage of gaze fixation and duration on the predefined target areas can be given a higher efficiency index and this value can be weighted based on the self report responses to questions and inquiries relating to ease of use and user experience.

Efficiency Index for task T with target areaset A=Emotive Efficiency Index for T with target areaset A+Cognitive efficiency Index for T with target areaset A

Where Cognitive efficiency index for task T with targetset A=High cognitive efficiency index for T with targetset A if >0

Otherwise, Low cognitive efficiency index for T with A

High cognitive efficiency index for T with A=sum of areas (geometric intersection of (high cognitive map, A)/Sum of plot areas in high cognitive map.

Low cognitive efficiency index for T with A=(−1)*sum of areas (geometric intersection of (high cognitive map, A)/Sum of plot areas in high cognitive map

Emotive efficiency index for task T with targetset A=High emotive efficiency index for T with targetset A if >0

Otherwise, Low emotive efficiency index for T with A

High emotive efficiency index for T with A=sum of areas (geometric intersection of (high emotive map, A)/Sum of plot areas in high emotive map

Low emotive efficiency index for T with A=(−1)*sum of areas (geometric intersection of (high emotive map, A)/Sum of plot areas in high emotive map

Other functions for combining the high/low emotive, cognitive efficiency indexes can also be derived using predictive models, described in the data mining books described herein, by relating the efficiency indexes to outcome variables such as the test group's behavior (e.g., like/dislike of a task T). Specific techniques that could be utilized include regression analysis for finding a relationship between completion times and outcome variables and using efficiency index as an indicator of the outcome variable.

The Frustration index can be determined as a function of behavioral responses that tend to indicate frustration, such as facial expressions and body movements and system input devices that can measure pressure, such as a pressure sensing computer mouse or other input device (for example, pressure and repetition of key presses applied to the keys of a keyboard). The frustration index can be weighted by one or more of a self-report measure of frustration and one or more biometric emotive measures.

Frustration index for task T=Sum of frustration indexes from pressure mouse responses, body movement, key presses, and facial expressions;

Frustration index for task T from pressure mouse=z-score of pressure mouse signals for task T in comparison to a database of tasks T-DB. Where T-DB is

Likewise, Frustration index for task T from keypresses=z-score of keypresses for task T in comparison to a database of tasks T-DB

The frustration index can also be restricted to specific target areas mentioned in self-report studies. For instance frustration index for task T from keypresses in target areaset A can only account for the keypresses within the target areaset A.

Note that other functions for frustration index for Task T can also be derived using predictive models, described in the data mining books described herein, by relating the input variables (key presses, pressure mouse signal values, etc.) to outcome variables such as testgroup's behavior (e.g., like/dislike of a task T). Specific techniques that could be utilized include regression analysis for finding a relationship between input and outcome variables and assuming frustration index as an indicator of the outcome variable.

The Appeal index of a task, process or experience can be determined as a function of a weighted combination (of one or more) of self report responses for likability, biometric emotive responses, and behavioral measures of micro and macro facial expressions, body or head lean toward the activity. The Appeal index can provide an indication of attractiveness by the user to the task, process or experience, with a high appeal index indicating a more enjoyable experience.

Appeal index for T=sum of (weight(s)*self report(T), weight(b1)*biometric responses(T,b1), weight(bn)*biometric responses(T,bn)), for i=1 to n.

Where bi is the ith biometric measure of n biometric measures.

Note that other functions for appeal index for Task T can also be derived using predictive models, described in the data mining books described herein, by relating the input variables (self report, head lean values, etc.) to outcome variables such as testgroup's behavior (e.g., like/dislike of a task T). Specific techniques that could be utilized include regression analysis for finding a relationship between input and outcome variables.

The Engagement index of a task, process or experience can be determined as a function of the Flow index, Appeal index, Biometric Emotive Power index and Biometric Cognitive Power index, for example:

Engagement Index=Flow Index+Appeal Index+Biometric Emotive Power Index+Biometric Cognitive Power Index

In addition, Biometric Persona or groupings can be created by identifying a group of users having a similarity of their pattern of task, process or experience metrics without regard to demographic or psychographic profile. Note that this grouping can utilize machine-based clustering algorithms for this grouping, or alternately may involve a manual process of an administrator/expert identifying the groupings or clusters of users.

Other embodiments are within the scope and spirit of the invention. For example, due to the nature of the scoring algorithm, functions described above can be implemented and/or automated using software, hardware, firmware, hardwiring, or combinations of any of these. Features implementing the functions can also be physically located at various positions, including being distributed such that the functions or portions of functions are implemented at different physical locations.

Further, while the description above refers to the invention, the description may include more than one invention.

1. A method of determining a measure of response of an audience to a presentation wherein the audience includes one or more members, the method comprising:
providing a biometric sensor device capable of measuring at least one biometrically based cognitive response to said presentation for each member of the audience;
exposing each member of the audience to the presentation over a period of time, wherein said period of time includes a plurality of points in time within the period of time;
providing a computer system connected to the biometric sensor device to receive data representative of the biometrically based cognitive response, said computer system including memory for storing the biometrically based cognitive response data;
for each member of the audience, measuring at least one biometrically based cognitive response to said presentation during the duration of the period of time and associating each measured biometrically based response with a point in time during the duration of the period of time in the memory of the computer system;
defining at least one event window corresponding to one or more points in time within the period of time, each event window having a predefined duration;
determining at least one biometric cognitive power index for the audience as a function of the measured biometrically based cognitive responses for all the audience members for at least one event window; and
generating a report indicating the biometric cognitive power index for said at least one event window.

2. A method of determining a measure of response of an audience to a presentation according to claim 1, wherein determining at least one biometric cognitive power index for the audience includes:
determining a biometrically based cognitive response threshold;
comparing each measured biometrically based cognitive response for each audience member for one event window to said threshold; and
counting the number of measured biometrically based cognitive responses that are greater than the threshold for each audience member.

3. A method of determining a measure of response of an audience to a presentation according to claim 2, wherein the biometrically based cognitive response threshold is the average biometrically based cognitive response for the audience member during the event window.

4. A method of determining a measure of response of an audience to a presentation according to claim 2, wherein determining at least one biometric cognitive power index for the audience includes:
determining the biometric cognitive power index as the sum of the number of measured biometrically based cognitive responses for one event window that are greater than the threshold for two or more audience members.

5. A method of determining a measure of response of an audience to a presentation according to claim 1, further comprising:
for one or more members of the audience, identifying a portion of the presentation being viewed and associating each viewed portion of the presentation with a point in time during the duration of the period of time; and
generating a biometric cognitive map as a function of the biometric cognitive power index for each event window and the portions of the presentation being viewed by the one or more members of the audience, the biometric cognitive map indicating areas of the presentation associated with high levels of cognitive activity of the audience.

6. A method of determining a measure of response of an audience to a presentation according to claim 5, wherein the biometric cognitive map is generated by aggregating the portions of the presentation viewed by one or more members of the audience who have a biometric cognitive response index above a predefined threshold.

7. A method of determining a measure of response of an audience to a presentation according to claim 5, further comprising:
providing a visual sensor device capable of identifying a portion of the presentation being viewed by each member of the audience.

8. A method of determining a measure of response of an audience to a presentation wherein the audience includes one or more members, the method comprising:
providing a biometric sensor device capable of measuring at least one biometrically based emotive response to said presentation for each member of the audience;
exposing each member of the audience to the presentation over a period of time, wherein said period of time includes a plurality of points in time within the period of time;
providing a computer system connected to the biometric sensor device to receive data representative of the biometrically based emotive response, said computer system including memory for storing the biometrically based emotive response data;
for each member of the audience, measuring at least one biometrically based emotive response to said presentation during the duration of the period of time and associating each measured biometrically based emotive response with a point in time during the duration of the period of time in the memory of the computer system;
defining at least one event window corresponding to one or more points in time within the period of time, each event window having a predefined duration;
determining at least one biometric emotive power index for the audience as a function of the measured biometrically based emotive responses for all the audience members for at least one event window; and
generating a report indicating the biometric emotive power index for said at least one event window.

9. A method of determining a measure of response of an audience to a presentation according to claim 8, wherein determining at least one biometric emotive power index for the audience includes:
determining a biometrically based emotive response threshold;
comparing each measured biometrically based emotive response for each audience member for one event window to said threshold; and
counting the number of measured biometrically based emotive responses that are greater than the threshold for each audience member.

10. A method of determining a measure of response of an audience to a presentation according to claim 9, wherein the biometrically based emotive response threshold is the average biometrically based emotive response for the audience member during the event window.

11. A method of determining a measure of response of an audience to a presentation according to claim 9, wherein determining at least one biometric emotive power index for the audience includes:
determining the biometric emotive power index as the sum of the number of measured biometrically based emotive responses that are greater than the threshold for two or more audience members.

12. A method of determining a measure of response of an audience to a presentation according to claim 8, further comprising:
for one or more members of the audience, identifying a portion of the presentation being viewed and associating each viewed portion of the presentation with a point in time during the duration of the period of time; and
generating a biometric emotive map as a function of the biometric emotive power index for each event window and the portions of the presentation being viewed by the one or more members of the audience, the biometric emotive map indicating areas of the presentation associated with high levels of emotive activity of the audience.

13. A method of determining a measure of response of an audience to a presentation according to claim 12, wherein the biometric emotive map is generated by aggregating the portions of the presentation viewed by one or more members of the audience who have a biometric emotive response index above a predefined threshold.

14. A method of determining a measure of response of an audience to a presentation according to claim 12, further comprising:
providing a visual sensor device capable of identifying a portion of the presentation being viewed by each member of the audience.

15. A computerized system for determining a measure of response of an audience to a presentation, wherein the audience includes two or more members, the system comprising:
a presentation device adapted to expose the audience to the presentation over a period of time, wherein said period of time includes a plurality of points in time within the period of time;
a biometric sensor device capable of measuring at least one biometrically based cognitive response to said presentation for each member of the audience;
a computer system connected to the biometric sensor device to receive data representative of the biometrically based cognitive response, said computer system including memory for storing the biometrically based cognitive response data;
the computer system including:
a recording module adapted to store the biometrically based cognitive response data generated in response to said presentation during the duration of the period of time in the memory of the computer system and adapted to associate the biometrically based cognitive response data with a point in time during the duration of the period of time in the memory of the computer system; and
a processing module adapted to determine at least one biometric cognitive power index for the audience as a function of the measured biometrically based cognitive response data for all the audience members for at least one event window and generate a report indicating the biometric cognitive power index for said at least one event window.

16. A computerized system for determining a measure of response of an audience to a presentation according to claim 15, wherein the processing module compares the biometrically based cognitive response data associated with one event window to a biometrically based cognitive response threshold and determines a count of biometrically based cognitive response data elements that are greater than the threshold for the one event window.

17. A computerized system for determining a measure of response of an audience to a presentation according to claim 16, wherein the processing module determines the biometrically based cognitive response threshold as the average over the biometrically based cognitive response data elements associated with the one event window.

18. A computerized system for determining a measure of response of an audience to a presentation according to claim 16, wherein the processing module determines the biometrically based cognitive power index as a function of the counts of biometrically based cognitive response data elements that are greater than the threshold for two or more audience members.

19. A computerized system for determining a measure of response of an audience to a presentation according to claim 15, wherein:
the recording module is adapted to receive and store eye tracking data generated in response to said presentation during the duration of the period of time in the memory of the computer system and adapted to associate the eye tracking data with a point in time during the duration of the period of time in the memory of the computer system, the eye tracking data including an identification of portions of the presentation being viewed by the members of the audience at a point in time during the duration of the period of time; and
the processing module is adapted to generate a biometric cognitive map as a function of the biometric cognitive power index for each event window and the portions of the presentation being viewed by the one or more members of the audience, the biometric cognitive map indicating areas of the presentation associated with high levels of cognitive activity of the audience.

20. A computerized system for determining a measure of response of an audience to a presentation according to claim 19, wherein the processing module generates the biometric cognitive map by aggregating the portions of the presentation viewed by one or more members of the audience who have a biometric cognitive response index above a predefined threshold.

21. A computerized system for determining a measure of response of an audience to a presentation according to claim 20, further comprising a visual sensor device capable of identifying a portion of the presentation being viewed by each member of the audience.

22. A computerized system for determining a measure of response of an audience to a presentation, wherein the audience includes two or more members, the system comprising:
a presentation device adapted to expose the audience to the presentation over a period of time, wherein said period of time includes a plurality of points in time within the period of time;
a biometric sensor device capable of measuring at least one biometrically based emotive response to said presentation for each member of the audience;
a computer system connected to the biometric sensor device to receive data representative of the biometrically based emotive response, said computer system including memory for storing the biometrically based emotive response data;
the computer system including:
a recording module adapted to store the biometrically based emotive response data generated in response to said presentation during the duration of the period of time in the memory of the computer system and adapted to associate the biometrically based emotive response data with a point in time during the duration of the period of time in the memory of the computer system; and
a processing module adapted to determine at least one biometric emotive power index for the audience as a function of the measured biometrically based emotive response data for all the audience members for at least one event window and generate a report indicating the biometric emotive power index for said at least one event window.

23. A computerized system for determining a measure of response of an audience to a presentation according to claim 22, wherein the processing module compares the biometrically based emotive response data associated with one event window to a biometrically based emotive response threshold and determines a count of biometrically based emotive response data elements that greater than the threshold for the one event window.

24. A computerized system for determining a measure of response of an audience to a presentation according to claim 23, wherein the processing module determines the biometrically based emotive response threshold as the average of the biometrically based emotive response data elements associated with the one event window.

25. A computerized system for determining a measure of response of an audience to a presentation according to claim 23, wherein the processing module determines the biometrically based emotive power index as a function of the counts of biometrically based emotive response data elements that are greater than the threshold for two or more audience members.

26. A computerized system for determining a measure of response of an audience to a presentation according to claim 22, wherein:
the recording module is adapted to receive and store eye tracking data generated in response to said presentation during the duration of the period of time in the memory of the computer system and adapted to associate the eye tracking data with a point in time during the duration of the period of time in the memory of the computer system, the eye tracking data including an identification of portions of the presentation being viewed by the members of the audience at a point in time during the duration of the period of time; and
the processing module is adapted to generate a biometric emotive map as a function of the biometric emotive power index for each event window and the portions of the presentation being viewed by the one or more members of the audience, the biometric emotive map indicating areas of the presentation associated with high levels of emotive activity of the audience.

27. A computerized system for determining a measure of response of an audience to a presentation according to claim 26, wherein the processing module generates the biometric emotive map by aggregating the portions of the presentation viewed by one or more members of the audience who have a biometric emotive response index above a predefined threshold.

28. A computerized system for determining a measure of response of an audience to a presentation according to claim 26, further comprising a visual sensor device capable of identifying a portion of the presentation being viewed by each member of the audience.

29. A method of determining a measure of response of an audience to a presentation wherein the audience includes one or more members, the method comprising:
providing a first biometric sensor device capable of measuring at least one biometrically based cognitive response to said presentation for each member of the audience;
providing an eye tracking sensor device capable of determining one or more gaze locations over a presentation image where at least one member of the audience is looking;
exposing each member of the audience to the presentation over a period of time, wherein said period of time includes a plurality of points in time within the period of time;
providing a computer system connected to the first biometric sensor device and the eye tracking sensor device to receive data representative of the biometrically based cognitive response, and eye tracking data, said computer system including memory for storing the biometrically based cognitive response data, and eye tracking data;
for each member of the audience, measuring at least one biometrically based cognitive response to said presentation during the duration of the period of time and associating each measured biometrically based cognitive response with a point in time during the duration of the period of time in the memory of the computer system;
for at least one member of the audience, determining one or more locations over one or more images of the presentation where said at least one audience member is looking and associating each of the locations with a point in time during the duration of the period of time in the memory of the computer system;
determining at least one cognitive impact index for the audience as a function of the measured biometrically based cognitive responses for all the audience members and the gaze locations for the presentation for at least one event window; and
generating a report indicating the biometric cognitive impact index for said at least one event window.

30. A method of determining a measure of response of an audience to a presentation according to claim 29, wherein determining at least one biometric cognitive impact index for said at least one event window includes:
defining at least one event window corresponding to one or more points in time within the period of time, each event window having a predefined duration;
determining a measure of high biometric cognitive visual coverage index for the audience as a function of the measured biometrically based cognitive responses for all the audience members during an event window, one or more gaze locations determined during the event window and the total gaze area of the presentation, where the biometric cognitive response is above a predefined threshold;
determining a measure of low biometric cognitive visual coverage index for the audience as a function of the measured biometrically based cognitive responses for all the audience members during an event window, one or more gaze locations determined during the event window and the total gaze area of the presentation, where the biometric cognitive response is below a predefined threshold;
determining a cognitive impact index as a function of the high biometric cognitive visual coverage index and low biometric cognitive visual coverage index.
generating a report indicating the high biometric cognitive visual coverage index, the low biometric cognitive visual coverage index, and the cognitive impact index for said at least one event window.

31. A method according to 30 wherein the cognitive impact index is determined as the high cognitive coverage index minus the low cognitive coverage index for said at least one event window.

32. A method of determining a measure of response of an audience to a presentation wherein the audience includes one or more members, the method comprising:
providing a first biometric sensor device capable of measuring at least one biometrically based emotive response to said presentation for each member of the audience;
providing an eye tracking sensor device capable of determining one or more gaze locations over a presentation image where at least one member of the audience is looking;
exposing each member of the audience to the presentation over a period of time, wherein said period of time includes a plurality of points in time within the period of time;
providing a computer system connected to the first biometric sensor device to receive data representative of the biometrically based emotive response, and eye tracking data, said computer system including memory for storing the biometrically based emotive response data;
for each member of the audience, measuring at least one biometrically based emotive response to said presentation during the duration of the period of time and associating each measured biometrically based emotive response with a point in time during the duration of the period of time in the memory of the computer system;
for at least one member of the audience, determining one or more locations over one or more images of the presentation where said at least one audience member is looking and associating each of the locations with a point in time during the duration of the period of time in the memory of the computer system;
determining at least one emotive impact index for the audience as a function of the measured biometrically based emotive responses for all the audience members and the gaze locations for the presentation for at least one event window; and
generating a report indicating the biometric emotive impact index for said at least one event window.

33. A method of determining a measure of response of an audience to a presentation according to claim 32, wherein determining at least one biometric emotive impact index for said at least one event window includes:
defining at least one event window corresponding to one or more points in time within the period of time, each event window having a predefined duration;
determining a measure of high biometric emotive visual coverage index for the audience as a function of the measured biometrically based emotive responses for all the audience members during an event window, one or more gaze locations determined during the event window and the total gaze area of the presentation, where the biometric emotive response is above a predefined threshold;
determining a measure of low biometric emotive visual coverage index for the audience as a function of the measured biometrically based emotive responses for all the audience members during an event window, one or more gaze locations determined during the event window and the total gaze area of the presentation, where the biometric emotive response is below a predefined threshold;
determining an emotive impact index as a function of the high biometric emotive visual coverage index and low biometric emotive visual coverage index.
generating a report indicating the high biometric emotive visual coverage index, the low biometric emotive visual coverage index, and the emotive impact index for said at least one event window.

34. A method according to 33 wherein the emotive impact index is determined as the high emotive coverage index minus the low emotive coverage index for said at least one event window.

35. A method of determining a measure of response of an audience to a presentation wherein the audience includes one or more members, the method comprising:
providing a first biometric sensor device capable of measuring at least one biometrically based cognitive response to said presentation for each member of the audience;
providing a second biometric sensor device capable of measuring at least one biometrically based emotive response to said presentation for each member of the audience;
providing an eye tracking sensor device capable of determining one or more gaze locations over a presentation image where at least one member of the audience is looking;
exposing each member of the audience to the presentation over a period of time, wherein said period of time includes a plurality of points in time within the period of time;
providing a computer system connected to the first and second biometric sensor devices and the eye tracking sensor device to receive data representative of the biometrically based cognitive response, data representative of the biometrically based emotive response, and eye tracking data, said computer system including memory for storing the biometrically based cognitive response data, the biometrically based emotive response data and eye tracking data;
for each member of the audience, measuring at least one biometrically based cognitive response and at least one biometrically based emotive response to said presentation during the duration of the period of time and associating each measured biometrically based cognitive response and each measured biometrically based emotive response with a point in time during the duration of the period of time in the memory of the computer system;
for at least one member of the audience, determining one or more locations over one or more images of the presentation where said at least one audience member is looking and associating each of the locations with a point in time during the duration of the period of time in the memory of the computer system;
defining at least one event window corresponding to one or more points in time within the period of time, each event window having a predefined duration;
determining a measure of high biometric cognitive visual coverage index for the audience as a function of the measured biometrically based cognitive responses for all the audience members during an event window, one or more gaze locations determined during the event window and the total gaze area of the presentation, where the biometric cognitive response is above a predefined threshold;
determining a measure of high biometric emotive visual coverage index for the audience as a function of the measured biometrically based emotive responses for all the audience members during an event window, one or more gaze locations determined during the event window and the total gaze area of the presentation, where the biometric emotive response is above a predefined threshold;
determining a measure of low biometric cognitive visual coverage index for the audience as a function of the measured biometrically based cognitive responses for all the audience members during an event window, one or more gaze locations determined during the event window and the total gaze area of the presentation, where the biometric cognitive response is below a predefined threshold;
determining a measure of low biometric emotive visual coverage index for the audience as a function of the measured biometrically based emotive responses for all the audience members during an event window, one or more gaze locations determined during the event window and the total gaze area of the presentation, where the biometric emotive response is below a predefined threshold; and
generating a report indicating the high biometric cognitive visual coverage index, high biometric emotive visual coverage index, low biometric cognitive visual coverage index and low biometric emotive visual coverage index for said at least one event window.

36. A method according to claim 35, further comprising
determining a high visual impact index as a function of the high biometric cognitive visual coverage index and high biometric emotive visual coverage index.

37. A method according to claim 35, further comprising
determining a low visual impact index as a function of the low biometric cognitive visual coverage index and low biometric emotive visual coverage index.
